(19) United States
(12) Patent Application Publication
(10) Pub. No.: US 2025/0143489 A1
(43) Pub. Date: May 8, 2025

(54) SCREEN SYSTEM AND STRUCTURE

(71) Applicant: Korn Wall Limited, Lewisham (GB)

(72) Inventors: Alan Murrell, Lewisham (GB); Michael Korn, Lewisham (GB); Christopher Hough, Lewisham (GB); Logan Beswick, Lewisham (GB); Edward Slater, Lewisham (GB); Margarida Santos, Lewisham (GB)

(21) Appl. No.: 18/837,574

(22) PCT Filed: Feb. 6, 2023
(86) PCT No.: PCT/GB2023/050260

§ 371 Date: Aug. 9, 2024

(30) Foreign Application Priority Data
Feb. 10, 2022 (GB) 2201754.5
Jul. 27, 2022 (GB) 2210985.4

(51) Int. Cl. A47G 5/02; E04B 2/74

(52) U.S. Cl. CPC A47G 5/02; E04B 2/7416

(57) ABSTRACT

A screen system for deployment over a surface is disclosed herein. The screen system comprises a first screen structure (550) and a second screen structure (553). Each screen structure comprises a panel element (544a,554b) attached to at least one support element (501a,501b,503a,503b), wherein the at least one support element and the panel element are attached to and configured to be rollable about a rotor (516a,516b) configured to rotate about a longitudinal axis to provide for extension and retraction thereof along a direction generally perpendicular to the longitudinal axis. The rotor of the second screen structure is configured to be moveable relative to the rotor of the first screen structure.

### FIELD OF THE INVENTION

The present disclosure relates to a screen system and structure.

### BACKGROUND

Bistable extendable members, also referred to as “bistable reeled composites” (BRCs) and/or “split tube extendable members” (“STEMs”) and/or “split tubes” and/or “extendible sheet members” and/or “bistable composite elements”, are elements which are configurable between two stable forms: a rigid longitudinally extending structure, and a compact coil of flat rolled up material. In the compact coiled/rolled up form, a bistable extendable member can be rolled up/wound/coiled about a first axis. In the rigid longitudinally extending form, the bistable extendable member longitudinally extends straight along a second axis which is perpendicular to the first axis.

Bistability in a bistable extendable member arises as a result of the manipulation of the Poisson's ratio and isotropy in the various layers of material making up the bistable extendable member. Bistable extendable members can be made from fibre-reinforced composite materials, for example glass fibres in a thermoplastic matrix, which are consolidated under conditions of elevated temperature and pressure.

Due to their mechanical properties of being extendable and retractable again into a wound or rolled up state, bistable extendable members can be useful in retractable structures such as retractable panels, screens, walls, dividers and/or partitions, such as those described in WO2019201948A1 and EP3251562B1.

WO8808620 describes an elongate element in the form of a longitudinally split tube. U.S. Pat. No. 6,217,975B1 describes an extendable sheet member which is configurable between first and second states. U.S. Pat. No. 6,602,574B1 describes an extendible, coilable member which is reversibly configurable between a coiled form and an extended form. WO9962811 describes a compound member formed from at least two extendible, coilable members, each of which is reversibly configurable between a coiled form and an extended form. U.S. Pat. No. 6,256,938B1 describes an elongate element in the form of a longitudinally split tube which is arranged to be progressively flattened and wound about an axis extending transversely to the longitudinal extent of the tube to form a coil.

Portable screen structures can be used to temporarily divide areas in a room, for example in a healthcare setting to reduce the risk of cross-infection from e.g., coronavirus. However, it can be difficult to create temporary screen structures that can divide more complex spaces that involve bends and corners, for example around a patient's bed.

The present disclosure seeks to alleviate, at least to a certain degree, the problems and/or address at least to a certain extent, the difficulties associated with the prior art.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

In a first aspect there is provided a screen system for deployment over a surface such as a floor. The screen system comprises a first screen structure (which may be attached to a wall) and a second screen structure (which may be moveable across a surface such as a floor), wherein each screen structure comprises a panel element attached to at least one support element, wherein the at least one support element and the panel element are attached to and configured to be rollable about a rotor configured to rotate about a longitudinal axis to provide for extension and retraction thereof along a direction generally perpendicular to the longitudinal axis. The rotor of the second screen structure is configured to be moveable relative to the rotor of the first screen structure.

The least one support element of the first screen structure may be pivotably coupled to the second screen structure, such that the angle of the panel element of the first screen structure relative to the rotor of the second screen structure is adjustable. The support element may be pivotably coupled to an elongate support post/support structure or spine element having a longitudinal axis parallel to longitudinal axis of rotor (for example, via a hinged bracket as described below in more detail).

The second screen structure may comprise a first base portion configured to be engageable with a surface over which the second screen structure is deployed or is to be deployed to support the rotor and therefore panel in an upright orientation generally perpendicular to the surface.

It will be understood that in the context of the present disclosure, there is a complex balance between the need of the first base portion to provide stability to the rotor but also to provide manoeuvrability and minimise footprint and trip hazard.

The first base portion may be operable between a first moveable configuration and a second parked configuration, wherein in the first moveable configuration the relative position of the rotor of the second screen structure across the surface is moveable relative to the rotor of the first screen structure, but wherein in the second parked configuration movement of the rotor of the second screen structure across the surface relative to the rotor of the first screen structure is inhibited.

It will be understood that when movement of the rotor of the second screen structure across the surface relative to the rotor of the first screen structure being inhibited is described, this does not mean that the rotor of the second screen structure cannot rotate, instead it means that movement of the rotor of the second screen structure across the surface is inhibited.

It will also be understood that in examples where each screen structure comprises a housing enclosing the rotor and any panel and support elements wound onto the rotor, that in the first moveable configuration the relative position of the housing of the second screen structure across the surface is moveable relative to the housing of the first screen structure, but wherein in the second parked configuration movement of the housing of the second screen structure across the surface relative to the housing of the first screen structure is inhibited.

The second screen structure may comprise an actuating mechanism, operable by retraction or extension of the at least one support element and the panel element, to move the first base portion between the first moveable configuration and the second parked configuration. In some examples the actuating mechanism may be activated by rotation of the rotor of the second screen structure. However, in other examples the second screen structure comprises a handle element for extending and retracting the at least one support element and the panel element upon application of a force to the handle element, wherein at least a portion of the handle element is configured to engage the actuating mechanism to move the first base portion between the first moveable configuration and the second parked configuration, such that when the handle element bears against the actuating mechanism the first base portion is held in the first moveable configuration, and when the handle element no longer bears against the actuating mechanism the first base portion is in the second parked configuration.

The second screen structure may comprise a guide element configured to receive at least a portion of the handle element and configured to guide at least a portion of the handle element towards the actuating mechanism. The at least a portion of the handle element being guided may be a protrusion configured to be received by a recess or channel in the guide element to guide retraction of the at least one support element and the panel element.

The handle element of the second screen structure may comprise an engagement portion configured to be guided by the guide element and configured to engage the locking mechanism. It will also be understood that the handle element may comprise additional components such as a flap extending the length of the handled element designed to increase the privacy provided by the handle element when the panel is in an extended position

The screen system may further comprise a locking mechanism to removably secure the handle element of the second screen structure to the first base portion, wherein the locking mechanism is actuatable by a lock actuating means. The lock actuating means may, for example, be located on the handle element of the second screen structure, a screen extension and/or on the first base portion, for example the first base portion may comprise a pedal to operate the locking mechanism to release the handle element. Additionally, or alternatively the locking mechanism may be actuatable in response to a force being applied above a selected threshold level of force (e.g., a jerking motion).

The first base portion may comprise rolling means and a shroud element, and wherein in the first moveable configuration the at least one shroud element is raised relative to the rolling means to permit movement of the rolling means on the surface, and wherein in the second parked position the at least one shroud element is lowered relative to the rolling means to engage the surface and inhibit movement of the rolling means on the surface.

The actuating mechanism may comprise a lever arm, and wherein at least a portion of the handle element is configured to engage the lever arm to actuate the actuating mechanism to lift or lower the shroud element of the first base portion relative to the rolling means. The lever arm may be coupled to the shroud via an eccentric pivot. The actuating mechanism may comprise a bell crank.

Additionally, or alternatively, the actuating mechanism may comprise a hydraulic piston and wherein at least a portion of the handle element is configured to engage a hydraulic actuator in a first axis to actuate the hydraulic piston to lift or lower the shroud element of the first base portion relative to the rolling means in a direction transverse to the first axis.

The handle element of the second screen structure has a longitudinal axis, and the handle element of the second screen structure may comprise a second base portion configured to support the handle element, and thereby the panel element, in a generally perpendicular orientation relative to the surface, and parallel to the longitudinal axis of the rotor of the second screen structure.

In some examples, as the handle element of the second screen structure bears against the actuating mechanism to move the first base portion between the second parked position and the first moveable position, the second base portion coupled to the handle element is raised off of the surface by the first base portion.

The second base portion of the handle element of the second screen structure may comprise rolling means configured to permit relative movement of the second base portion of the handle element of the second screen structure relative to the surface. However, it will also be appreciated that the second base portion may be a static base without rolling means.

The first screen structure may comprise at least one hinge arrangement coupled to the rotor of the first screen structure (e.g., indirectly via a frame/spine element supporting the rotor) and configured to provide for the rotor of the first screen structure to pivot about a second longitudinal axis arranged generally parallel to the longitudinal axis of the rotor of the second screen structure. The at least one hinge may comprise a hinged bracket as described below with reference to, for example, FIGS. 14A to 15B, and 17 and 18. The at least one hinge may be biased so that it is configured to return to a neutral position or alternatively biased so that it is easier to move or deflect in one direction than the other. This may additional help prevent damage occurring to the support element.

The at least one support element of each screen structure may comprise a bistable extendable member, such as a composite split tube extendable member, each having a longitudinal edge arranged generally perpendicular to the first longitudinal axis and to which the panel element is attached, each of the at least one bistable extendable members being configurable in a first state in which it is at least partially rolled up about the first longitudinal axis, and a second state in which it is at least partially longitudinally extended along the direction generally perpendicular to the first longitudinal axis.

In another aspect there is provided a screen structure for deployment over a surface. The screen structure comprises a panel element attached to at least one support element, wherein the at least one support element and the panel element are attached to and configured to be rollable about a rotor configured to rotate about a longitudinal axis to provide for extension and retraction thereof along a direction generally perpendicular to the longitudinal axis, and a first base portion configured to be engageable with and support the rotor in an upright orientation relative to the surface over which the screen structure is deployed or is to be deployed. The first base portion is operable between a first moveable configuration and a second parked configuration, wherein in the first moveable configuration the relative position of the rotor of the screen structure across the surface is moveable, but wherein in the second parked configuration movement of the rotor of the screen structure across the surface is inhibited. The screen structure and first base portion may hold the rotor and therefore panel in an upright orientation such that the longitudinal axis is in a direction generally perpendicular to the surface.

The screen structure may further comprise an actuating mechanism, operable by retraction or extension of the at least one support element and the panel element, to move the first base portion between the first moveable configuration and the second parked configuration.

The screen structure may further comprise a handle element for extending and retracting the at least one support element and the panel element upon application of a force to the handle element. At least a portion of the handle element may be configured to engage the actuating mechanism to move the first base portion between the first moveable configuration and the second parked configuration, such that when the handle element bears against the actuating mechanism the first base portion is held in the first moveable configuration, and when the handle element no longer bears against the actuating mechanism the first base portion is in the second parked configuration.

The first base portion may comprise a guide element configured to receive at least a portion of the handle element and configured to guide at least a portion of the handle element towards the actuating mechanism. The at least a portion of the handle element being guided may be a protrusion configured to be received by a recess in the guide element to guide retraction of the at least one support element and the panel element.

The screen structure may further comprise a locking mechanism to removably secure the handle element of the second screen structure to the first base portion, wherein the locking mechanism is actuatable by a lock actuating means on the handle element of the second screen structure.

The first base portion may comprise rolling means and a shroud element, and wherein in the first moveable configuration the at least one shroud element is raised relative to the rolling means to permit movement of the rolling means on the surface, and wherein in the second parked position the at least one shroud element is lowered relative to the rolling means to engage the surface and inhibit movement of the rolling means on the surface.

The locking means may comprise a lever arm, and wherein the handle element is configured to engage the lever arm to actuate the locking mechanism to lift or lower the shroud element of the first base portion relative to the rolling means. The lever arm may be coupled to the shroud via an eccentric pivot.

The at least one support element may comprise a bistable extendable member, such as a composite split tube extendable member, each having a longitudinal edge arranged generally perpendicular to the first longitudinal axis and to which the panel element is attached, each of the at least one bistable extendable members being configurable in a first state in which it is at least partially rolled up about the first longitudinal axis, and a second state in which it is at least partially longitudinally extended along the direction generally perpendicular to the first longitudinal axis.

In another aspect there is provided a screen system for deployment over a surface. The screen system comprises a first rotor and a second rotor each having respective longitudinal axes, wherein both rotors are coupled to opposite ends of a panel element attached to at least one support element, wherein the at least one support element and the panel element are attached to and configured to be rollable about the rotors to provide for extension and retraction thereof along a direction generally perpendicular to the respective longitudinal axes. The rotor of the second screen structure is configured to be moveable relative to the rotor of the first screen structure.

In some examples, at least one of the rotors is coupled to a first base portion configured to be engageable with a surface over which the second screen structure is deployed or is to be deployed to support the rotor and therefore panel in an upright orientation generally perpendicular to the surface. The first base portion may be operable between a first moveable configuration and a second parked configuration, wherein in the first moveable configuration the relative position of the rotor of the second screen structure across the surface is moveable relative to the rotor of the first screen structure, but wherein in the second parked configuration movement of the rotor of the second screen structure across the surface relative to the rotor of the first screen structure is inhibited.

Both rotors may be coupled to respective base portions operable between a first moveable configuration and a second parked configuration.

At least one of the rotors may be coupled to at least one hinge arrangement and configured to provide for the rotor to pivot about a longitudinal axis arranged generally parallel to the longitudinal axis of the rotor.

In another aspect there is provided a hinged bracket for supporting a screen structure. The hinged bracket comprises a first portion configured to clamp a support element, the support element coupled to a panel element, and a second portion for affixing to a wall or spine element. The first portion is hinged relative to the second portion. The second portion is biased relative to the first portion such that movement of the second portion relative to the first portion is stiffer in a first direction compared to movement of the second portion relative to the first portion in a second direction opposite to the first direction.

The support element may comprise a bistable extendable member, the bistable extendable member having a concave surface and a convex surface, and wherein the first direction corresponds to a direction towards the concave surface of the support element and away from the convex surface of the support element.

The first portion may be configured to clamp a portion of the support element in a curved or arcuate configuration.

The second portion may be configured to slot within a channel of a spine element and/or handle element.

The bias of the hinged bracket may be provided by a pair of opposing springs, and wherein one of the springs is arranged to provide a stronger biasing force than the other such that movement of the second portion relative to the first portion is stiffer in a first direction compared to movement of the second portion relative to the first portion in a second direction opposite to the first direction.

In some examples, each of the first portion and the second portion have a central axis extending through their mid-point, and wherein the hinge comprises a rotation axis, and wherein the rotation axis is offset from the central axis.

The first portion may be larger than the second portion and wherein the first portion comprises a pair of knuckles arranged either side of a knuckle or knuckles of the second portion.

In another aspect there is provided a screen system comprising the hinged bracket of the aspect described above, and a panel element coupled to at least one support element, wherein the at least one support element and the panel element are configured to be rollable about a longitudinal axis, to provide for extension and retraction thereof along a direction generally perpendicular to the longitudinal axis.

In another aspect there is provide a screen system comprising a panel element coupled to at least one support element, wherein the at least one support element and the panel element are configured to be rollable about a first longitudinal axis, to provide for extension and retraction thereof along a direction generally perpendicular to the first longitudinal axis. The support element is a bistable extendable member that has an arcuate cross section when in an unrolled state in a direction parallel to the first longitudinal axis and a flat cross-section when in a rolled state. The screen system further comprises a clamp element for clamping a portion of the at least one support element, wherein the clamp element is configured to clamp a portion of the at least one support element in a profile corresponding to the unrolled state.

The screens system may further comprise a spine element for supporting the panel element and support element, the spine element comprising at least one channel for receiving the clamp element.

The clamp element may be configured to clamp a portion of the at least one support element and a portion of the panel element.

In another aspect there is disclosed a screen system. The screen system comprises a panel element coupled to at least one support element, wherein the at least one support element and the panel element are configured to be rollable about a first longitudinal axis, to provide for extension and retraction thereof along a direction generally perpendicular to the first longitudinal axis, and wherein the support element is a bistable extendable member that has an arcuate cross section when in an unrolled state in a direction parallel to the first longitudinal axis and a flat cross-section when in a rolled state. The screen system also comprises a clamp element for clamping a portion of the at least one support element, wherein the clamp element is configured to clamp a portion of the at least one support element in a profile corresponding to the unrolled state.

The screen system may comprise a spine element for supporting the panel element and support element, the spine element comprising at least one channel for receiving the clamp element.

The clamp element may be configured to clamp a portion of the at least one support element and a portion of the panel element.

In another aspect there is provided bracket for clamping a bistable extendable member, the bistable extendable member operable between a rolled configuration wherein the bistable extendable member is substantially flat, and an unrolled configuration wherein the bistable extendable member has a curved cross-sectional profile. The bracket is configured to clamp the bistable extendable member in the curved, unrolled configuration.

The bracket may comprise a curved receiving portion and a cramp part. The curved receiving portion may be curved to follow the profile of the curvature of the cross-sectional profile of the bistable extendable member. The cramp part may be configured to clamp the bistable extendable member in the receiving portion in the curved, unrolled configuration.

The receiving portion may be configured to be coupled to at least one of a spine element and a handle element.

The bracket has a longitudinal axis parallel to the longitudinal axis of the bistable extendable member when clamped by the bracket in use, and the bracket may be configured to be coupled to the at least one of a spine element and a handle element via a removable fastening means extending in the longitudinal axis of the bracket.

The cramp part may be configured to be removably fastened to the receiving portion to clamp the bistable extendable member therebetween.

The cramp part may be configured to be removably fastened to the receiving portion via removable fastening means extending in a direction perpendicular to the longitudinal axis of the bracket. Optionally the removable fastening means is configured to pass through the bistable extendable member.

The cramp part may be configured to be removably fastened to the receiving portion via an interference fit.

The bracket may further comprise a cover plate, wherein the cover plate is configured to be received by the receiving portion to cover the cramp part in use.

The receiving portion may comprise a pair of opposing lips extending parallel to the longitudinal axis of the bracket configured to receive and engage the cover plate via an interference fit to cover the cramp part.

In another aspect there is provided a screen structure for deployment over a surface. The screen structure comprises a panel element attached to at least one handle element, wherein the at least one panel element is attached to and configured to be rollable about a rotor configured to rotate about a longitudinal axis to provide for extension and retraction thereof along a direction generally perpendicular to the longitudinal axis. The screen structure also comprises a first base portion configured to be engageable with and support the rotor in an upright orientation relative to the surface over which the screen structure is deployed or is to be deployed, and a second base portion coupled to the handle element and configured to support the handle element in an upright orientation relative to the surface over which the screen structure is deployed or is to be deployed. The second base portion is shaped to mate with the first base portion of another screen structure, so as to enable the handle element to be close to the rotor of the other screen structure to minimise the gap between panel elements of adjacent screen structures.

In another aspect there is provided a screen system comprising a plurality of screen structures as mentioned above. In such a screen system, the second base portion of a first screen structure may comprise a region configured to follow the profile of the first base portion of a second screen structure.

The first base portion of the plurality of screen structures may comprise rolling means and a shroud element, and wherein the second base portion of the plurality of screen structures may comprise a region configured to follow the profile of the shroud element.

The second base portion of the plurality of screen structures may be coupled to the handle of each respective screen structure and may comprise a first region on a side of the second base portion proximate to the at least one panel element and support element, and a second region on a side of the second base portion distal to the panel element and at least one support element. The second region of the second base portion is shaped to have a profile that corresponds to the profile of the shroud element so that the second region of the second base portion is configured to abut the shroud element of an adjacent screen system

In another aspect there is disclosed a screen structure comprising a panel element attached to at least one support element, wherein the at least one support element and the panel element are attached to and configured to be rollable about a rotor configured to rotate about a longitudinal axis to provide for extension and retraction thereof along a direction generally perpendicular to the longitudinal axis. The screen structure further comprises a magnetic cover for covering at least a portion of the panel element and at least one support element when rolled about the rotor, and a handle element for extending and retracting the at least one support element and the panel element upon application of a force to the handle element. The handle element comprises at least one magnet for coupling with the magnetic cover of an adjacent screen structure.

The handle element may extend in a direction parallel to the longitudinal axis, and wherein the handle element comprises a screen extension extending perpendicularly from the handle element, and wherein the screen extension comprises at least one magnet for coupling with the magnetic cover of an adjacent screen structure.

The screen extension may extend in the longitudinal axis for approximately the same length as the at least one support element and the panel element.

The screen extension may comprise a pair of magnets at opposing ends of the screen extension in the longitudinal axis.

### DRAWINGS

Embodiments of the disclosure will now be described, by way of example only, with reference to the accompanying drawings, in which:

FIG. 1A shows a perspective view of a bistable extendable member in a partially rolled up state;

FIG. 1B shows a perspective view of the bistable extendable member of FIG. 1A in a fully rolled up state;

FIG. 1C shows a perspective view of the bistable extendable member of FIG. 1A in a fully longitudinally extended state;

FIG. 2A shows the cross-sectional profile of the bistable extendable member of FIG. 1A when it is in a rolled up state, as in FIG. 1B;

FIG. 2B shows the cross-sectional profile of the bistable extendable member of FIG. 1A when it is in a longitudinally extended state, as in FIG. 1C;

FIG. 3A shows a front view of a screen structure in a fully extended position;

FIG. 3B shows a front view of the screen structure of FIG. 3A in a partially extended position;

FIG. 4A shows a rear perspective view of a screen structure in a fully extended position;

FIG. 4B shows a front perspective view of the screen structure of FIG. 4B in a partially extended position;

FIG. 5 shows a perspective view of an example screen system comprising two screen structures;

FIG. 6 shows a side view of a base portion of the second screen structure of the screen system of FIG. 5;

FIG. 7 shows a side view of a base portion of the second screen structure of the screen system of FIG. 5 as the handle element approaches the base portion;

FIG. 8 shows a perspective view of a base portion of the second screen structure of the screen system of FIG. 5;

FIG. 9 shows a perspective view of a base portion of the second screen structure of the screen system of FIG. 5 as the handle element approaches the base portion;

FIG. 10 shows a perspective view of the underside of a base portion of the second screen structure of the screen system of FIG. 5;

FIG. 11 shows another perspective of the base portion of the second screen structure of the screen system of FIG. 5;

FIG. 12A shows a perspective view of another example embodiment of a base portion for use for example with the screen system of FIG. 5;

FIG. 12B shows a side view cross-section of the example base portion of FIG. 12A;

FIG. 13 shows a perspective view of another example embodiment of a screen system;

FIG. 14A shows a perspective view of an example hinged bracket for supporting a screen structure;

FIG. 14B shows a side view of the example hinged bracket of FIG. 14A;

FIG. 15A shows a perspective view of another example hinged bracket for supporting a screen structure;

FIG. 15B shows a side view of the example hinged bracket of FIG. 15A;

FIG. 16 shows a perspective view of a clamp element for clamping a portion of a support element;

FIG. 17 shows a perspective view of an example hinged bracket also comprising a clamp element;

FIG. 18 shows a perspective view of another example hinged bracket also comprising a clamp element;

FIG. 19 shows a cross-section through another example bracket 1900;

FIG. 20 shows a perspective view of an example handle and screen extension of embodiments of the disclosure;

FIG. 21 shows another perspective view of the example handle and screen extension of FIG. 20; and

FIG. 22 shows another perspective view of the example handle and screen extension of FIGS. 20 and 21 further showing the second base portion comprising a region mating with the first base portion of another screen system.

### SPECIFIC DESCRIPTION

A detailed description of example screen structures comprising a base portion to support the screen structure and provide self-returnability thereto shall now be given. It should be understood that the example base portion described herein is not limited to only being used to support the screen structures described herein and may alternatively be used to equal effect to support different screen structures, for example any screen structure which rolls up (extends/retracts) or which does not roll up and which is fixed. The example base portion described herein could be used to support many different sizes of structures/panels when extended, e.g. a screen structure of around 1-5 m wide×1-5 m high when substantially fully extended such as a screen structure of around 3 m wide×2 m high.

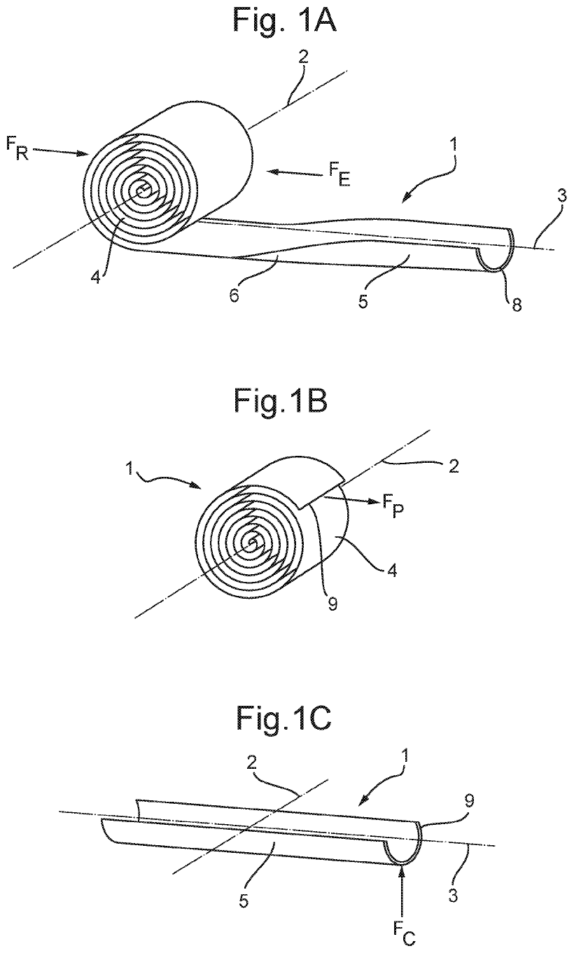

FIG. 1A illustrates an example support 1 which is a bistable extendable member. The bistable extendable member 1 is configurable in a first state in which the bistable extendable member 1 is rolled up (i.e. coiled) about a first axis 2, and a second state in which the bistable extendable member 1 is longitudinally extended along a second axis 3 which is perpendicular to the first axis 2. As shown in FIG. 1A, the bistable extendable member 1 can be in both the first state and the second state at the same time when the bistable member is partially coiled up or extended. For example, a first portion 4 of the bistable extendable member 1 can be in the first coiled state, and simultaneously, a second portion 5 of the bistable extendable member can be in the second extended state, with a transition portion 6 between the first portion 4 and the second portion 5. In the examples discussed herein, the bistable extendable member 1 comprises a bistable composite split tube extendable member. However, it is also to be understood that any other bistable extendable member(s) may be employed, such as a non-composite bistable extendable member, or any other bistable reeled composite or bistable split tube extendable member.

FIG. 1B shows the bistable extendable member 1 when it is fully in the first state. That is, when the entire length of the bistable extendable member 1 is rolled up about the first axis 2. Conversely, FIG. 1C shows the bistable extendable member 1 when it is fully in the second state. That is, when the entire length of the bistable extendable member 1 is longitudinally extended along the second axis 3.

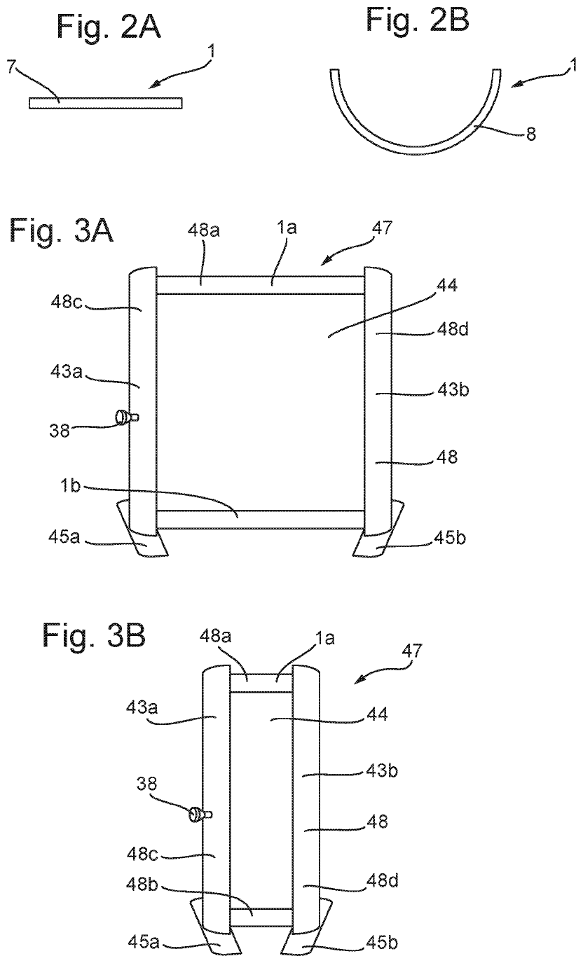

As shown in FIG. 2A, when the bistable extendable member 1 is in the first state, in a plane which is normal to the second axis 3, the bistable extendable member 1 has a cross-sectional profile 7 which is substantially flat and straight. This is also shown in FIG. 1B.

As shown in FIG. 2B, when the bistable extendable member 1 is in the second state, in a plane which is normal to the second axis 3, the bistable extendable member 1 has a cross-sectional profile 8 which is C-shaped. That is, when the bistable extendable member 1 is in the second state, it curves upwards at its longitudinal edges. This is also shown in FIGS. 1A and 1C.

With reference to FIG. 1A, the bistable extendable member 1 is selectively configurable between the first state and the second state. The bistable extendable member 1 can be progressively rolled up by applying a rolling force FR to the first portion 4 to cause an increase in the length of the bistable extendable member 1 which is rolled up to form the first portion 4 and conversely a decrease in the length of the bistable extendable member 1 which is extended to form the second portion 5. Conversely, the bistable extendable member 1 can be progressively longitudinally extended by applying an extending force FE to the first portion 4 to cause an increase in the length of the bistable extendable member 1 which is extended to form the second portion 5 and a decrease in the length of the bistable extendable member 1 which is rolled up to form the first portion 4.

With reference to FIG. 1B, when the bistable extendable member 1 is fully in the first state, i.e., when it is fully rolled up, a pulling force FP can be applied to the outwardly facing end 9 of the bistable extendable member 1 in order to initiate the longitudinal extension of the bistable extendable member 1 to form the second portion 5. The extending force FE can then be applied as in FIG. 1A to increase the length of the bistable extendable member 1 which is extended to form the second portion 5, as desired. Similarly, as shown in FIG. 1C, when the bistable extendable member 1 is fully in the second state, i.e., when it is fully longitudinally extended, a coiling force, FC, can be applied to the end 9 of the bistable extendable member 1 to initiate the rolling up of the bistable extendable member 1 to start forming the first portion 4.

An exemplary application of the bistable extendable member 1 described herein shall now be described, with reference to FIGS. 3A and 3B, which show an exemplary screen structure 47.

In the screen structure 47, a first bistable extendable member 1a and a second bistable extendable member 1b (which may hereinafter be referred to collectively as “bistable extendable members 1”) are employed as upper and lower members 48a, 48b respectively, of a frame 48. Side members 48c, 48d of the frame 48 are provided by aluminium supports 43a and 43b respectively. A panel 44 comprising a flexible polymer film (though panels of other materials such as other polymers and/or textiles may also be employed) is arranged to hang substantially flat in the plane defined by the frame 48 and may be attached to the upper and lower members 48a, 48b directly, or via one or more zips. The aluminium supports 43a and 43b are each attached to respective base portions 45a, 45b. Supports 43a and 43b and base portions 45a, 45b are at least on their own light enough for a user to pick up and move (‘pick and place’) them around, making the structure 47 highly portable and independently movable. One or more handles and/or knobs and/or other protruding elements may be attached to the support 43a or 43b and arranged to protrude therefrom, to make it easier for a user of the screen structure 47 to grip and hold the supports 43a or 43b, to improve the ergonomics of the screen structure 47. A knob 38 is shown on support 43a and could equally be applied to support 43b.

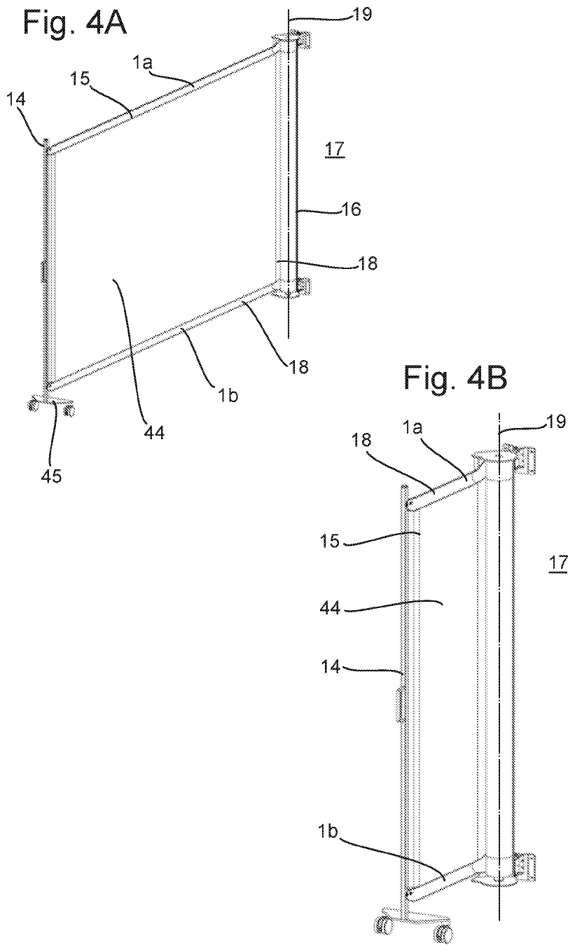

By means of the two states of the bistable extendable members 1a and 1b, the frame 48 and thus also the panel 44 can be progressively rolled up or extended, due to the bistable properties of the bistable extendable members 1a and 1b, as described above in relation to the bistable extendable member 1. FIG. 3A shows the structure 47 and thus the panel 44 in a fully extended position wherein the bistable extendable members 1a, 1b are fully longitudinally extended, as in FIG. 1C. FIG. 3B shows the structure 47 and thus the panel 44 in a partially extended position wherein the bistable extendable members 1a, 1b are partially longitudinally extended, as in FIG. 1A. Once lifted, a pushing or pulling force can be applied to the support 43a or support 43b to cause the frame 48 and the panel 44 to be retracted/rolled up/closed or extended/pulled out/opened respectively about one or more rotors 16 (not shown in FIGS. 1 to 3B but shown in FIGS. 4A and 4B). The supports 43a and/or 43b as described herein may be referred to as being ‘handle elements’ in so far as, amongst other things, they function to allow a user to extend and retract the frame 48 and panel 44 once they have been picked one up, moved it and placed it on the ground in another location so as to extend or retract the frame (i.e. the supports 43a and/or 43b allow a user to extend or retract the frame 48 and panel 44 upon application of a force thereto). In the example shown in FIGS. 3A and 3B each support 43a, 43b may comprise a respective rotor, or only one of the supports 43a, 43b may comprise a rotor for receiving and rolling the at least one support element 1 and panel 44.

In the example shown in FIGS. 3A and 3B, the supports 43a, 43b are sized and shaped such that when the structure 47 and the panel 44 are in a substantially fully retracted position (not shown), the supports 43a, 43b will abut one another. Thus, the geometry of the supports 43a, 43b provides that the support 43a may only be positioned and orientated relative to the support 43b in one particular position and orientation, which may be designed to be a desired position and orientation which leaves a leading end portion of the bistable extendable members 1a, 1b slightly extended, to avoid mechanical fastenings (not shown) which attach the leading end of each of the bistable extendable members 1 to the support 43a, from rubbing on the coiled portion 4 (see FIG. 1A) of the bistable extendable members 1, thus reducing the likelihood of damage to the bistable extendable members 1.

FIGS. 4A and 4B show an alternative exemplary screen structure 15 which is mounted to a generally vertical wall 17. It is though envisaged that the screen structure 15 may be mounted to any other surface, such as a generally vertical post, or a piece of furniture. Alternatively, it is also envisaged that the screen structure 15 may be adapted to be freestanding, i.e., not mounted to a surface such as a wall.

The screen structure 15 is generally similar to the screen structure 47 shown in FIGS. 3A and 3B, in that it comprises supports in the form of bistable extendable members 1a and 1b, and a panel 44. Though, instead of aluminium supports 43a and 43b (as in FIGS. 3A and 3B), an elongate handle element 14 and a rotor 16 form a frame 18 together with the bistable extendable members 1a, 1b, inside which the panel 44 is arranged. The elongate handle element 14 and the rotor 16 may be formed of aluminium, or any other suitable metal or other material(s). In the example described herein, the bistable extendable members 1a, 1b comprise bistable composite split tube extendable members, though it is envisaged that any other bistable extendable members may be employed. The handle element 14 is attached to a second base portion 45.

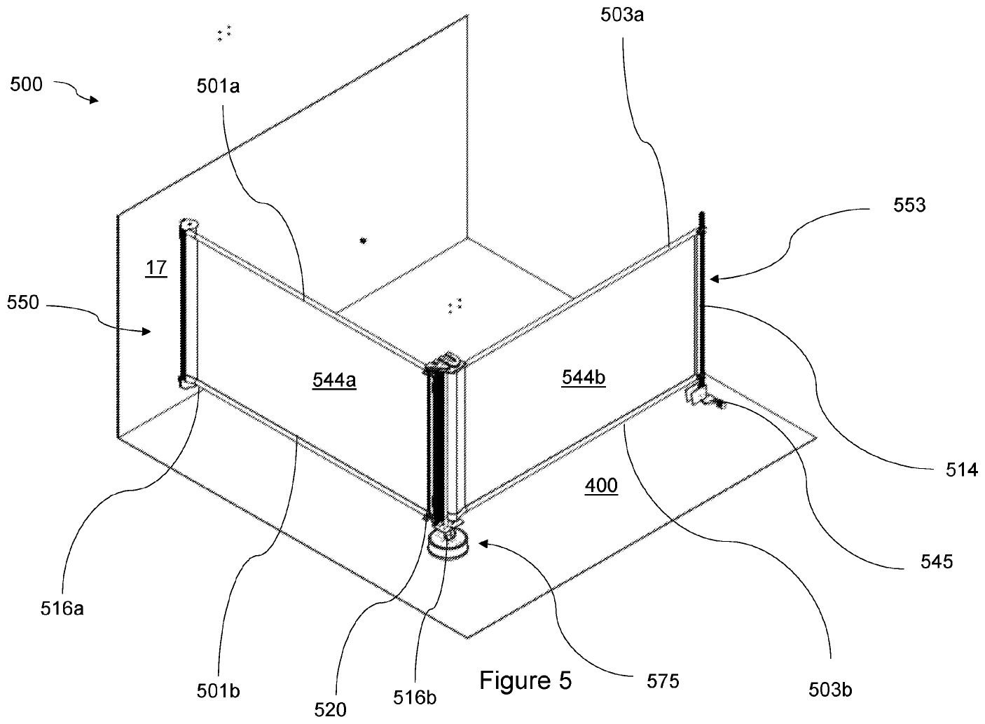

In the example shown, the handle element 14 comprises a generally straight elongate member having a generally square cross-sectional profile. A pushing or pulling force can be applied to the handle element 14 to cause the bistable extendable members 1a, 1b and the panel 44 to be retracted/rolled up/closed or extended/pulled out/opened respectively about the rotor 16 about a first longitudinal axis 19 corresponding to the axis of rotation of the rotor 16 (see FIGS. 5A and 5B).

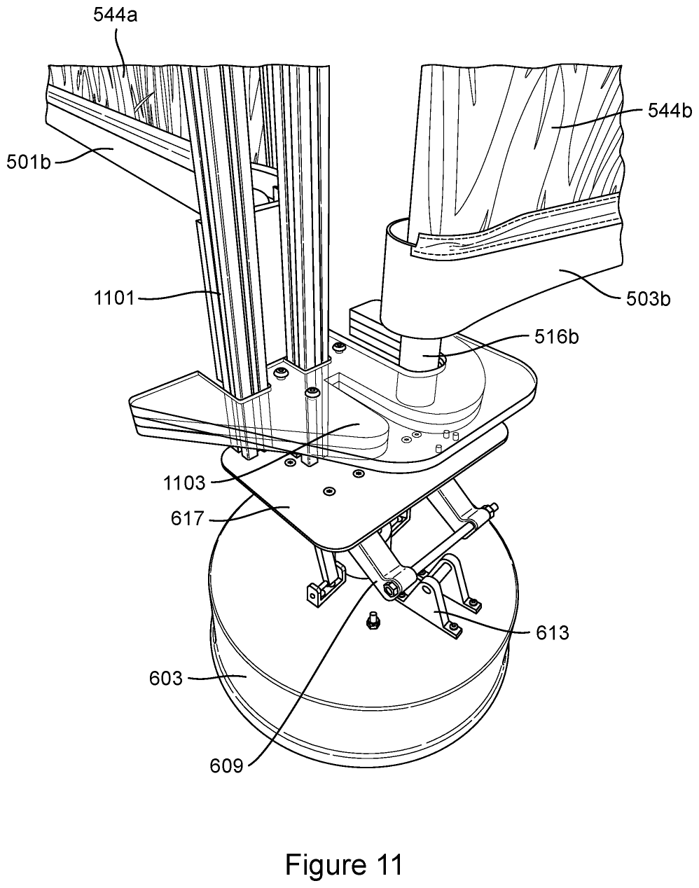

In some examples the screen structure may also comprise an optional spine element (as shown, for example, in FIG. 11) comprising a generally straight elongate member having a generally rectangular cross-sectional profile, although it will be understood that other cross-sectional profiles such as a circular cross-sectional profile may be used. The spine element may be arranged to provide structural support and stiffness to the screen structure 15. In some examples the spine element may provide a housing for the rotor 516a, 516b and the panel element 544a, 544b rolled upon the rotor 516a, 516. The housing may be elongate to substantially enclose and support the rotor 516a, 516b, with an elongate aperture extending along the longitudinal axis of the rotor 516a, 516b for permitting the panel element 544a, 544b and support element 510a, 510b, 503a, 503b to retract/extend from the rotor 516a, 516b within the housing.

The optional spine element may optionally include one or more channels for slidably receiving one or more other components and/or mechanical fastenings, such as one or more hinge arrangements which at least attach the structure 15 to the generally vertical wall 17 and/or one or more hinged brackets (as described in more detail below) for attaching to the support and optionally panel elements. The spine element may therefore be formed from an aluminium extrusion, for ease of manufacture and assembly. One or more handles and/or knobs and/or other protruding elements may be attached to the handle element 14 and arranged to protrude therefrom, to make it easier for a user of the screen structure 15 to grip and hold the handle element 14, to improve the ergonomics of the screen structure 15.

It is also envisaged that alternative shapes, sizes and configurations of handle elements and spine elements may alternatively be employed in the screen structure 15 other than those which are shown in FIGS. 4A and 4B and described below.

FIG. 5 shows an example screen system 500 of embodiments of the disclosure for deployment over a surface 400. In the example shown, the screen system 500 comprises a first screen structure 550 and a second structure 553, and the surface is a floor. One or each screen structure 550, 553 may be similar and/or share similar functionality with the screen structure of FIGS. 4A and 4B, with like reference numbers denoting features with the same or similar functionality to those described above.

In the example shown, the first screen structure 550 is coupled to a vertical wall 17, whereas the second screen structure 553 is freestanding and coupled to the end of the panel element 544 of the first screen structure 550. However, in other examples both screen structures 550, 553 may be freestanding.

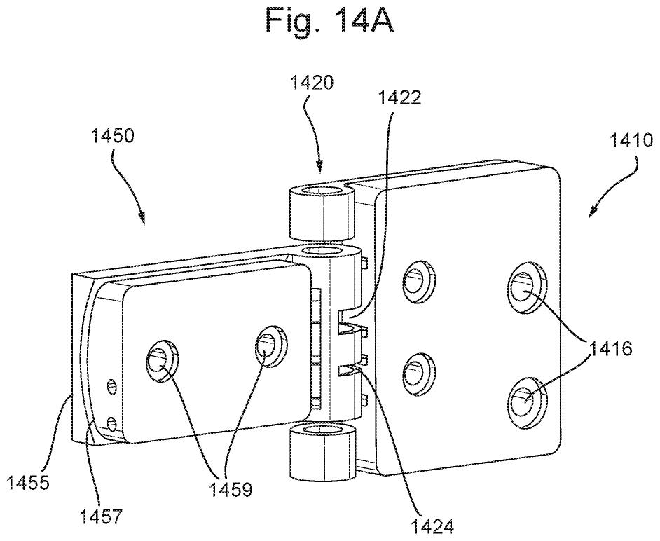

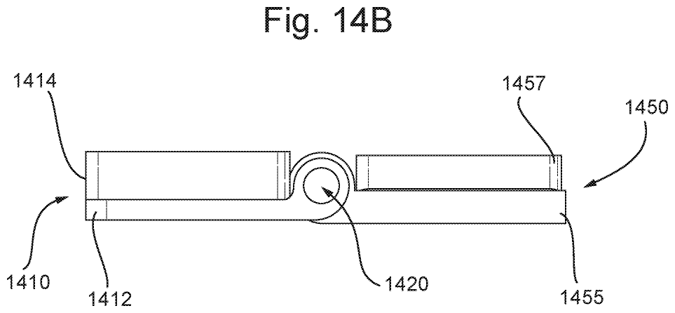

In the example shown in FIG. 5, the first screen structure 550 comprises a first panel element 544a supported by two support elements, a first split tube extendable member 501a, and a second split tube extendable member 501b, both extending horizontally either side of the central panel element 544a. The first screen structure 550 comprises an elongate frame adapted to hold a first rotor 516a in an orientation generally parallel to the wall 17. The support elements 501a, 501b may be coupled to the frame via respective hinges which may advantageously improve supporting the panel element 544a. As described below with reference to FIGS. 14A to 18, the respective hinges may be biased so that they are configured to return to a neutral position. This may additional help prevent damage occurring to the support elements 501a, 501b e.g., from rubbing against the frame.

The second screen structure 553 similarly comprises a second panel element 544b supported by two support elements, a first split tube extendable member 503a, and a second split tube extendable member 503b, both extending horizontally either side of the central panel element 544b. The panel elements 544a, 544b may comprise a flexible polymer film (though panels of other materials such as other polymers and/or textiles may also be employed) and are arranged to hang substantially flat in the plane defined by the support elements 501a, 501b, 503a, 503b.

The support elements 501a, 501b and the first panel element 544a of the first screen structure 550 are rollable about the first rotor 516a, and the support elements 503a, 503b and the second panel element 544b of the second screen structure 553 are rollable about a second rotor 516b, and therefore have one end coupled to each respective rotor 516a, 516b (for example one end of the support elements 501a, 501b of the first screen structure 501 may be coupled to the first rotor 516a of the first screen structure 501, and one end of the support elements 503a, 503b of the second screen structure 503 may be coupled to the second rotor 516b of the second screen structure 503). Both the first rotor 516a and the second rotor 516b extend in a generally upright vertical orientation and have a longitudinal axis which in this example is generally perpendicular relative to the surface of the floor 400. The support elements 501a, 501b, 503a, 503b and the panel elements 544a, 544b are therefore attached to and configured to be rollable about respective rotors 516a, 516b configured to rotate about a longitudinal axis to provide for extension and retraction thereof along a direction generally perpendicular to the longitudinal axis of rotation of the rotors 516a, 516b.

In the example shown in FIG. 5, the second screen structure 503 comprises a spine element 520 which in this example is a pair of generally straight elongate members having a generally rectangular cross-sectional profile, but it will be understood that only one elongate member may be used. The spine element 520 in this example is arranged to provide structural support and stiffness to the first screen structure 550 and has a longitudinal axis parallel to the longitudinal axis of the rotor 516b. The spine element 520 may be formed from an aluminium extrusion, for ease of manufacture and assembly. The spine element 520 in the example shown includes one or more optional channels for slidably receiving one or more other components and/or mechanical fastenings, such as one or more hinge arrangements (for example, the hinged brackets as described below in more detail with reference to FIGS. 14A to 15B and 17 and 18) which in this example couple to each of the support elements 501a, 501b of the first screen structure 550 such that the support elements 501a, 501b of the first screen structure 550 are pivotably coupled to the second screen structure 553. The spine element 520 and the rotor 516b of the second screen structure 553 are supported by a first base portion 575, and the spine element 520 and rotor 516b are offset relative to each other and/or the centre of the base portion 575, such that the angle of the panel element 544a of the first screen structure 550 relative to the rotor 516b of the second screen structure is adjustable.

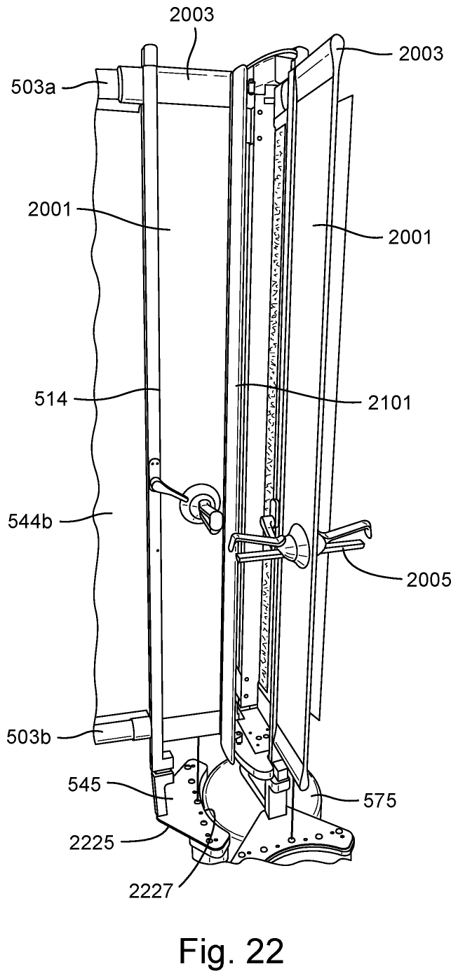

In the example shown, the second screen structure 553 comprises a handle element 514 coupled to each of the two support elements 503a, 503b and/or the panel element 544b of the second screen structure 553 and comprises a generally straight elongate member which in this example has a generally square cross-sectional profile (although other cross-sectional profiles may be used). A pushing or pulling force can be applied to the handle element 514 to cause the bistable extendable members 503a, 503b and the panel 544b to be retracted/rolled up/closed or extended/pulled out/opened respectively about the rotor 516b. The handle element 514 also comprises a second base portion for supporting the handle element 514. The second base portion 545 in this example comprises a rolling means in the form of a pair of castor wheels, configured to permit relative movement of the second base portion 545 of the handle element 514 of the second screen structure 553 relative to the surface 400, but it will be understood that in other examples other rolling means may be used or that no rolling means may be used at all and the second base portion 545 may be light enough for a user to pick up and move (‘pick and place’). As described below with reference to FIG. 22, the second base portion 545 may comprise a region configured to abut with the first base portion 575 of an adjacent screen structure.

The handle element 514 may be configured to nest with the first base portion 575 to aid in storage and reduce the space occupied on the surface 400, thereby minimising the risk of a trip hazard. Nesting of the handle element 514 with the first base portion 575 may also aid in retraction of the first screen structure 550 once the second screen structure 553 has been retracted. The handle element may also comprise means for gripping by a user, such as a knob like the knob 38 described above with reference to FIGS. 3A and 3B. In some examples the means for gripping by a user may comprise a

As described above, the second screen structure 553 comprises a moveable first base portion 575 configured to be engageable with the surface 400 over which the second screen structure 553 is deployed or is to be deployed to support the rotor 516b and therefore panel 544b in an upright orientation generally perpendicular to the surface 400.

The first base portion 575 is operable between a first moveable configuration and a second parked configuration, wherein in the first moveable configuration the relative position of the rotor 516b of the second screen structure 553 across the surface 400 is moveable relative to the rotor 516a of the first screen structure 550, but wherein in the second parked configuration movement of the rotor 516b of the second screen structure 553 across the surface 400 relative to the rotor 516a of the first screen structure 550 is inhibited.

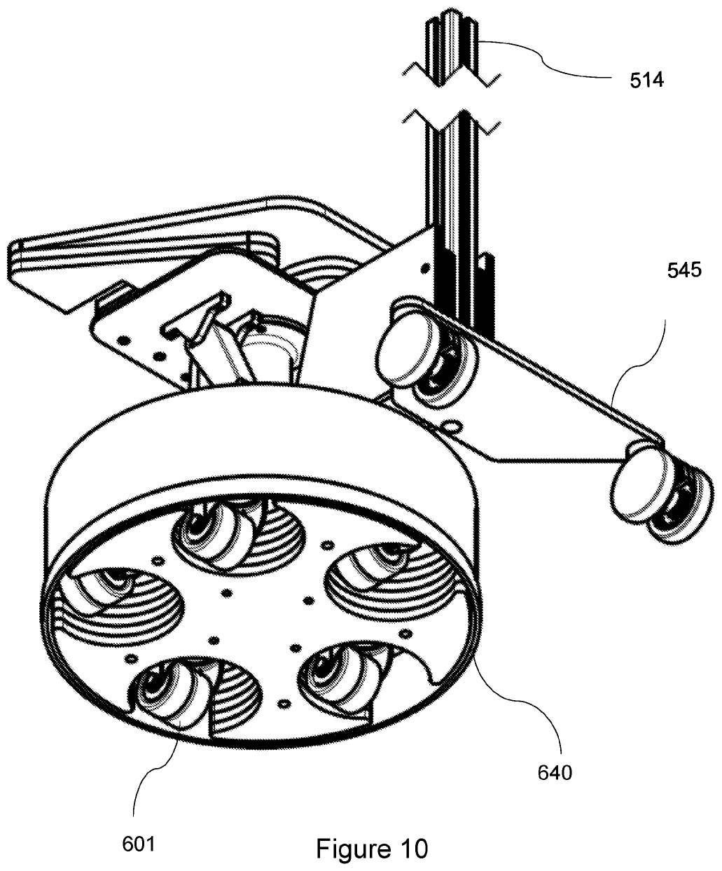

As can be seen more clearly in FIG. 10, the first base portion 575 supporting the rotor 516b of the second screen structure 553 comprises rolling means 601 mounted within a shroud element 603. In the first moveable configuration the at least one shroud element 603 is raised relative to the rolling means 601 to permit movement of the rolling means 601 on the surface 400, and wherein in the second parked configuration the at least one shroud element 603 is lowered relative to the rolling means 601 to engage the surface 400 and inhibit movement of the rolling means 601 on the surface 400. A central shaft 611 supports the actuating mechanism 609 and a support plate 617 for supporting the rotor 516b relative to the rolling means 601.

The rotor 516b may be supported by the support plate 617 relative to the shroud element 603 such that the longitudinal axis of the rotor 516b corresponds to the centre of the shroud element 603 and the central shaft 611. However, in preferred examples, the rotor 516b is offset from the base portion 575, the centre of the shroud element 603 and the central shaft 611. Offsetting the rotor 516b relative to the first base portion 575, the centre of the shroud element 603 and the central shaft 611 may improve extension of the second screen structure 553 when it is being extended at a different angle relative to the extension of the first screen structure 550. For example, offsetting the rotor 516b relative to the first base portion 575, the centre of the shroud element 603 and the central shaft 611 may encourage extension of the second screen structure 553 in the direction of the offset relative to the centre of the first base portion 575 and/or may provide increased stability when the second screen structure 553 and the first screen structure 550 are both extended, as shown for example in FIG. 5.

In some examples, at least one of the screen structures 550, 553 may comprise means to slow or brake rotation of the rotors 516a, 516b. It will be understood that each rotor 516a, 516b may be biased to return to a retracted configuration, for example each rotor 516a, 516b may comprise a spring such as a round spring loaded conveyor roller (of the type commonly found in roller blinds) to provide tension to the rotor 516a, 516b. In some examples one or both of the screen structures 550, 553 may comprise means to slow or inhibit rotation of the rotors 516a, 516b to slow retraction of the panel elements 544a, 544b. For example, there may a brake operable e.g., via an actuating means, such as in the handle element 514 or base portion 575 to slow rotation of the rotor 516b of the second screen structure 553.

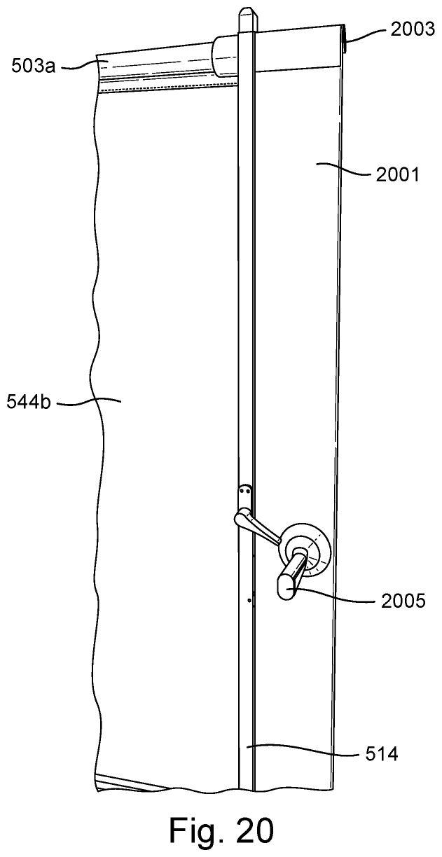

As will be described in more detail below with reference to FIGS. 20 to 22, in some examples a series of screen systems 500 may be used adjacent to each other, e.g., to provide privacy to a series of beds on a ward of a hospital. In such examples, it may be desirable to couple the handle element 514 and/or the base element 545 of the second screen structure 553 to a portion of an adjacent screen system, such as the base portion 575 of an adjacent screen system and/or the spine element 520 of an adjacent screen system. It will therefore be understood that the handle element 514 and/or second base portion 545 may comprise means to detachably couple to the first base portion 575 and/or spine element 520 of an adjacent screen system, and that the base portion 575 and/or spine element 520 may also comprise means to couple to the handle element 514 and/or second base portion 545 of an adjacent screen system. The means to detachably couple may comprise a latch or locking mechanism, or any other similar mechanism to permit detachable fastening.

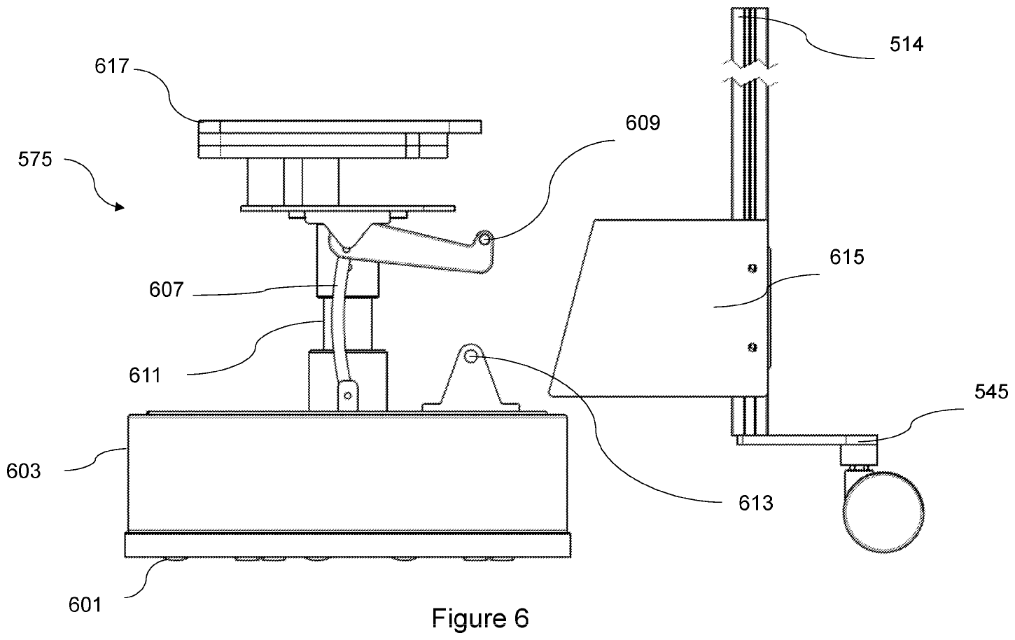

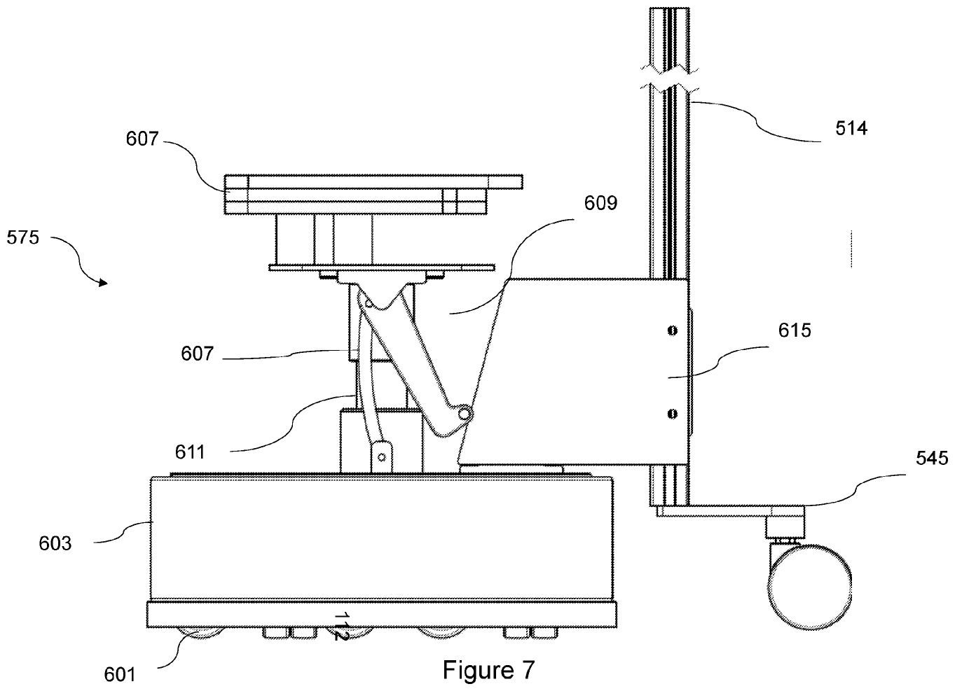

As shown more clearly in FIGS. 6 to 9 and 11, the shroud element 603 is circular but in other examples may form another shape, for a polygon such as a pentagon, hexagon etc. The shroud element 603 may also be tapered such that it is wider at its base. In the examples shown, the shroud element has a 350 mm diameter. To inhibit movement of the rolling means 601 on the surface 400 when in the second parked configuration, the shroud element 603 may also have a means to increase friction, such as a rubber ring 640 (as shown in FIG. 10), around the base of the shroud element 603, configured to engage the surface 400 when in the second parked configuration.

As can be seen in FIGS. 6 to 9 and 11, the first base portion 575 further comprises an actuating mechanism 609 operable to move the first base portion 575 between the first moveable configuration and the second parked configuration. In the examples shown, the actuating mechanism 609 is operable by retraction or extension of the at least one support element 5031, 503b and the panel element 544b, to move the first base portion 575 between the first moveable configuration and the second parked configuration.

In the example shown in FIGS. 6 to 9, the actuating mechanism 609 comprises a lever arm, which in this example is coupled to the shroud element 603 via an eccentric pivot and a bell crank 607, although the lever arm may equally engage, for example, a hydraulic piston to actuate movement of the shroud element 603 relative to the rolling means 601. However, it will be understood that in other examples the actuating mechanism 609 may take other forms; for example, the actuating mechanism 609 may be operated by rotation of the rotor 516b of the second screen structure 553. Additionally, or alternatively, the actuating mechanism 603 may comprise a hydraulic piston and wherein at least a portion of the handle element 514 is configured to engage a hydraulic actuator in a first axis to actuate the hydraulic piston to lift or lower the shroud element 603 of the base portion 575 relative to the rolling means 601 in a direction transverse to the first axis.

In the example shown in FIGS. 6 to 9 a portion of the handle element 514 is configured to engage the lever arm to actuate the actuating mechanism 609 to lift or lower the shroud element 603 of the first base portion 575 relative to the rolling means 601 and relative to central shaft 611 (that lies in the central axis of the shroud element 603) that acts to support the rotor 516b (via support plate 617) and the actuating mechanism 609 relative to the surface 400 and the rolling means 601.

As shown, for example, in FIGS. 6 to 9, at least a portion of the handle element 514 is configured to engage the actuating mechanism 609 to move the first base portion 575 between the first moveable configuration and the second parked configuration, such that when the handle element 514 bears against the actuating mechanism 609 the first base portion 575 is held in the first moveable configuration, and when the handle element 514 no longer bears against the actuating mechanism 609 the first base portion 575 is in the second parked configuration. To this end, in the examples shown the handle element 514 of the second screen structure 553 comprises an engagement portion 615 configured to engage the actuating mechanism 609. In the example shown, the engagement portion 615 is a protrusion projecting from the handle element 514 transverse to the longitudinal axis of the handle element 514. In the example shown the end face of the engagement portion 615 is sloped or inclined relative to the longitudinal axis of the handle element 514 to engage the actuating mechanism 609 to guide the actuating mechanism 609 to the first moveable configuration when it makes contact with the actuating mechanism 609.

As shown, for example, in FIG. 9, as the engagement portion 615 of the handle element 514 of the second screen structure 553 bears against the actuating mechanism 609 to move the first base portion 575 between the second parked position and the first moveable position, the second base portion 545 coupled to the handle element 514 is raised off of the surface 400 by the first base portion 575. Advantageously this may help in manoeuvrability if the screen structure as it is packed away.

In the examples shown, the base portion 575 also comprises a locking mechanism 613 to removably secure the handle element 514 of the second screen structure 553 to the first base portion 575. In the example shown, the locking mechanism 613 comprises a latch mechanism, comprising a horizontal bar (e.g., extending in a direction transverse to the longitudinal axis of the handle element 514 and transverse to the direction of protrusion of the engagement portion 615 from the handle element 514) coupled to the first base portion 575. The handle element also comprises a latch mechanism (not shown) configured to engage the horizontal bar to detachably secure the handle element 514 to the first base portion 575. The latch mechanism may be actuatable by a lock actuating means on the handle element 514 of the second screen structure 553 (for example by a means for gripping by a user, such as a handle or knob as described above) and/or on a screen extension (as described in more detail below with reference to FIG. 20). The lock actuating means may be, for example, a button or lever located in or on the handle element 514 and/or screen extension.

Additionally, or alternatively, the locking mechanism 613 may be configured to detach once a force above a selected threshold level of force is applied. For example, the locking mechanism 613 may be configured to release the handle element 514 if the handle element 514 is pulled with a force above a selected level of force. Advantageously, this may mean that the handle element 514 may be used to control movement of the first base portion 575 and thereby extension of the first screen structure 550 when the first base portion 575 is in the first moveable configuration, and extension of the second screen structure 553 when the first base portion 575 is in the second parked configuration (as when the first base portion 575 is in the second parked configuration it will be more resistant to movement and thereby if the user pulls on the handle element 514 they will detach the handle element 514 from the first base portion 575).

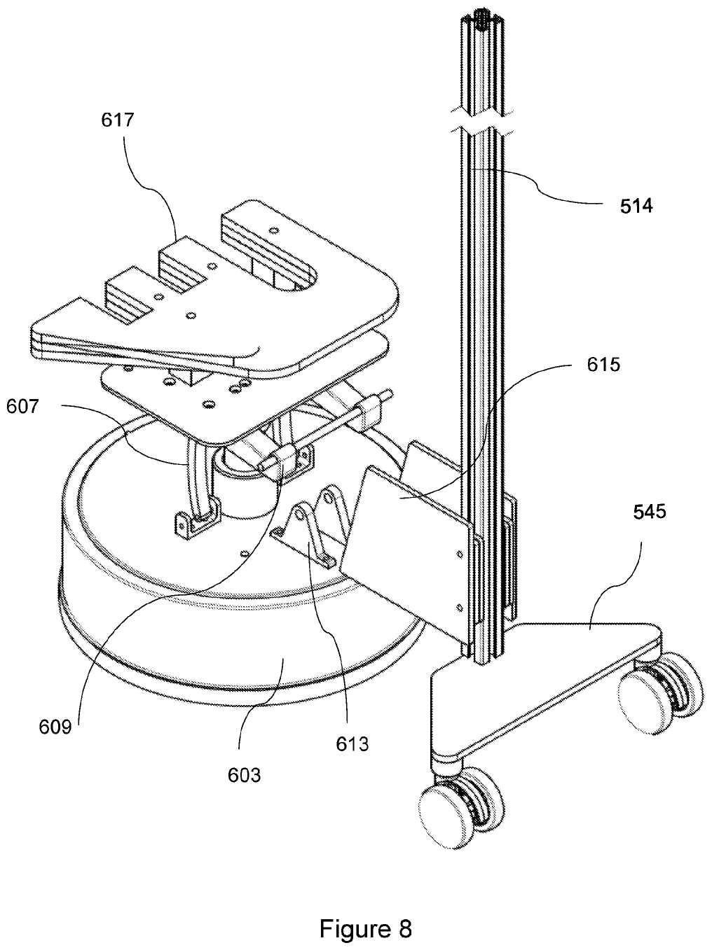

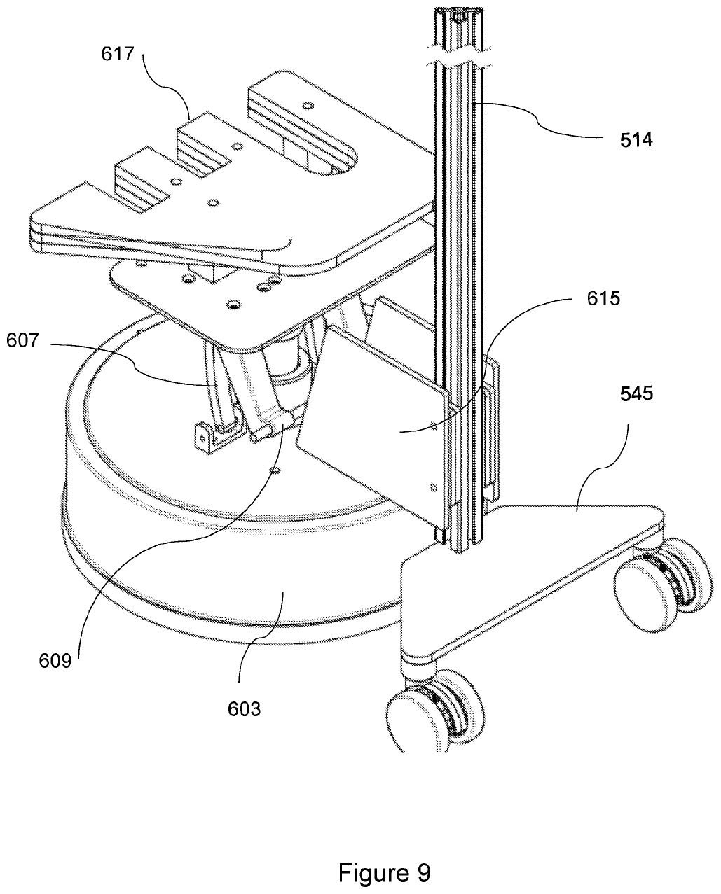

In some examples, as shown for example more clearly in FIGS. 8 and 9, the engagement portion 615 may comprise a pair of guide plates attached either side of the handle element 514, configured to pass either side of the locking mechanism 613 (which in this example has a width approximately the same as that of the handle element 514) to securely guide the handle element 514 into the correct position on the first base portion 575 to both engage the engagement portion 609 and/or the locking mechanism 613.

As can be seen, for example, in FIG. 10 the rolling means 601 comprise a plurality of rolling means (in this example, five) distributed evenly around the perimeter of the first base portion 575 which may advantageously act to improve stability of the first base portion 575 and thereby the screen structure when extending/retracting. In this example the rolling means comprise castor wheels. Each castor wheel is housed within a corresponding cylindrical recess within the shroud element 603 to permit movement in any of 360 degrees of movement.

In some examples the first base portion 575 also comprises a guide element 1103 for guiding retraction of the handle element 514 back towards the base portion. Advantageously the guide ensures that the handle element 514 approach the first base portion 575 to engage the actuating mechanism 609 and the locking mechanism 613. The guide element 1103 may be configured to engage with a corresponding protrusion (not shown) on the handle element 514 to guide movement of the handle element 514 towards the first base portion 575 as the second screen structure 553 is retracted. As can be seen in FIG. 11, the guide 1103 is in the form of a plate mounted above the support plate 617 (although it will be understood that in other examples it may be mounted below the support plate 617) and contains a central channel bounded on either side by curved portions to smoothly guide a corresponding protrusion on the handle element 514 into the central channel. The central channel may be aligned with the centre of the shroud element 603 to guide the protrusion on the handle element 514 (and thereby the handle element 514 itself) towards the centre of the first base portion 575. Dependent on the relative position of the rotor 516b (which may be off-centre relative to the centre of the first base portion 575 and the shaft 613), the curved portions of the guide element 1103 may differ in geometry; for example as can be seen in FIG. 11, a portion of the guide element 1103 closer to the rotor 516b may have a more rounded geometry (e.g., a smaller radius of curvature) than a portion of the guide further from the rotor 516 on the other side of the central channel relative to the rotor 516, which may have a more gradual radius of curvature (e.g., a larger radius of curvature). As can also be seen in FIG. 11, the guide element 1103 extends around the base of the rotor 516b mounted on support plate 617 to prevent the handle element 514 from rubbing against the panel 544b or support element 503b and thereby to protect the screen structure.

As can also be seen in FIG. 11, the screen structure here comprises a pair of spine elements 1101 which are in the form of elongate members extending parallel to the longitudinal axis of the rotor 516b and are supported on the support plate 617. The pair of spine elements may provide structure support and increased stiffness to the screen structure, particularly when the screen structure is being moved (e.g., retracted or extended) and pushed or pulled by a user. It can also be seen how the panel 544a and the support 501b of the first screen structure 550 are pivotably coupled to one of the spine elements 1101. This may allow the angle of the panel element 544a of the first screen structure 550 to be adjustable relative to the rotor 516b, and the panel 544b, of the second screen structure 553.

Although not shown in FIG. 11, it will be appreciated that in some examples there may be a corresponding guide element 1103 at the other end (i.e., the top) of the rotor 516 to also guide the handle element 514 near the top of the second screen structure 553 and to also protect the support 503a

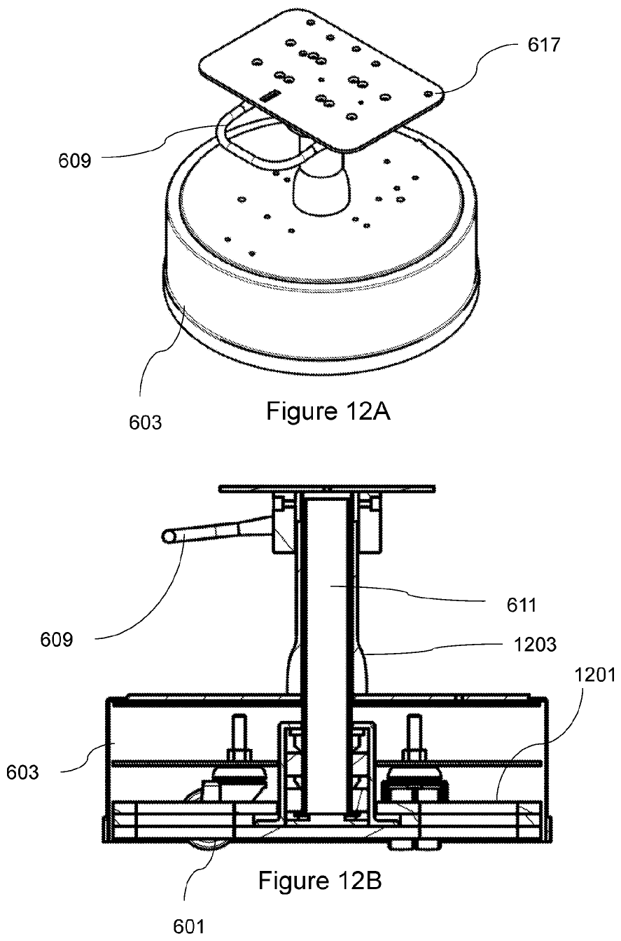

FIGS. 12A and 12B show a modification of the first base portion 575 of FIGS. 6 to 11, whereby in this example much of the actuating mechanism 609 (in particular the bell crank 607) is concealed within a circular duct 1203 coaxial with the central shaft 611. This may advantageously prevent any loose items being caught/trapped in the workings of the actuating mechanism 609. Also shown in FIGS. 12A and 12B are additional weights 1201 that have been distributed around the periphery of the base of the shroud element 603. Providing additional weights 1201 around the periphery of the base of the shroud element 603 may improve stability of the base portion 575 when in use. It will be understood that in the context of the present disclosure, there is a complex balance between the need of the base portion 575 to provide stability to the rotor but also to provide manoeuvrability and minimise footprint and trip hazard. Providing such weights 1201 around the periphery of the base of the shroud element 603 may improve stability and reduce footprint, without impacting on manoeuvrability.

It will be appreciated that although the first base portion 575 described above has been described in the context of a screen system comprising a first screen structure 550 and a second screen structure 553, in some examples the first base portion 575 may be used for a single screen structure (i.e., that does not require fixation to a wall).

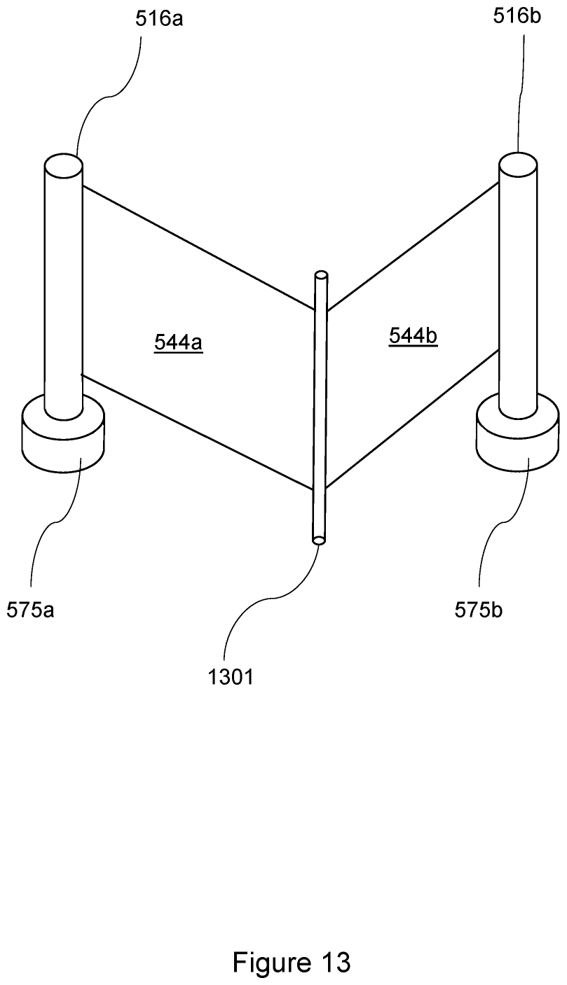

Additionally, or alternatively, rather than having a first screen structure 550 and a second screen structure 553 with the rotor 516b of the second screen structure 553 coupling to the handle element/end of the panel element 544a of the first screen structure 550, in some examples the rotors 516a, 516b of two screen structures may be at opposing ends of the system 500, for example as shown in FIG. 13.

For example, the screen system shown in FIG. 13 comprises a first screen structure having a first rotor 516a and a second screen structure having a second rotor 516b each having respective longitudinal axes. Both rotors 516a, 516b are coupled to opposite ends of respective panel elements 544a, 544b attached to at least one support element, wherein the at least one support element and the respective panel elements 544a, 544b are attached to and configured to be rollable about the respective rotors 516am 516b to provide for extension and retraction thereof along a direction generally perpendicular to the respective longitudinal axes.

In the example shown, each rotor 516a, 516b is supported by a respective base portion 575a, 575b (for example the first base portion 575 shown in FIGS. 5 to 12B) such that the rotor 516b of the second screen structure is configured to be moveable relative to the rotor 516a of the first screen structure and to support each rotor 516a, 516b and therefore panel 544a, 544b in an upright orientation generally perpendicular to the surface 400. As described above with reference to FIGS. 5 to 12B, the first base portion may be operable between a first moveable configuration and a second parked configuration, wherein in the first moveable configuration the relative position of the rotor 516b of the second screen structure across the surface 400 is moveable relative to the rotor 516a of the first screen structure, but wherein in the second parked configuration movement of the rotor 516b of the second screen structure across the surface 400 relative to the rotor of the first screen structure is inhibited.

In the example shown, the two panel elements 544a, 544b may be coupled together, for example via a hinge arrangement, to a supporting post 1301, although it will be understood that in other examples there may only be a single panel element, and the single panel element may comprise a support post 1301 arranged to support a portion of the single panel element, for example to support the single element around a bend. The support post 1301 may comprise a base portion, for example similar to the second base portion 545 described above. For example, the base portion may comprise rolling means configured to permit relative movement of the base element relative to the surface. However, it will also be appreciated that the base portion may be a static base without rolling means (for example a “pick and place” base). In such examples the base of the support post 1301 may have means to increase friction with the surface 400, such as a rubberised base.

While in the example shown in FIG. 13 both rotors 516a, 516b are coupled to respective base portions 575a, 575b, it will be appreciated that in some examples one of the rotors 516a, 516b may be coupled to at least one hinge arrangement and configured to provide for the rotor 516a, 516b to pivot about a longitudinal axis arranged generally parallel to the longitudinal axis of the rotor 516a, 516b, for example as shown in FIGS. 4A and 4B.

FIG. 14A shows a perspective view of an example hinged bracket for supporting a screen structure and FIG. 14B shows a side view of the example hinged bracket of FIG. 14A. In the example shown the hinged bracket comprises a first portion 1450 and a second portion 1410 via a hinge 1420 and that are biased relative to each other via a biasing means about the hinge 1420.

The first portion 1450 comprises a proximal portion 1455 and a distal portion 1457. The distal portion 1455 and proximal portion 1457 are both configured to clamp a portion of the support element (which in this example may be a split tube extendable member or bistable element) therebetween in an unrolled state. In the unrolled state the support element has an arcuate profile, and so as such the distal portion 1455 and proximal portion 1457 have a profile adapted to provide the arcuate profile to hold and clamp the support element therebetween in a curved configuration. To couple the distal portion 1455 and proximal portion 1457 together there are a pair of screw holes 1459 for a fastener such as a threaded bolt to pass therethrough and clamp the distal portion 1455 and proximal portion 1457 together and thereby clamp the support element therebetween.

The distal portion 1455 of the first portion 1450 also comprises a curved portion forming a knuckle configured to receive a bolt or pin therethrough to form the hinge 1420. In this way, the hinge 1420 has a rotation axis that is slightly off-centre from the central axis of the hinged bracket. The curved portion or knuckle also comprises a pair of recesses or cut-outs 1422, 1424 for receiving the biasing means (in this example, springs). The first cut-out 1422 is slightly larger than the second cut-out 1424. This is so the first cut-out can house a slightly larger spring than the spring of the second cut-out 1424 so as to provide a greater degree of biasing when there is movement about the hinge in one direction compared to an opposite direction.

In the example shown, the bias of the hinged bracket is provided by a pair of opposing springs, and wherein one of the springs is arranged to provide a stronger biasing force than the other such that movement of the second portion 1410 relative to the first portion 1450 is stiffer in a first direction compared to movement of the second portion 1410 relative to the first portion 1450 in a second direction opposite to the first direction.

The second portion 1410 also comprises a proximal portion 1412 and a distal portion 1414. In the example shown the proximal 1412 and distal 1414 portions are also configured to clamp together via a plurality of screw holes 1415. The second portion 1410 may be configured to attach to a wall or spine element, and/or a handle element.

The second portion 1410 is larger than the first portion 1450. The distal portion 1412 of the second portion 1410 also comprises a pair of curved portions or knuckles configured to receive a bolt or pin therethrough to form the hinge 1420. In this way, the hinge 1420 has a rotation axis that is slightly off-centre from the central axis of the hinged bracket. Because the second portion 1410 is larger than the first portion 1450, the pair of curved portions or knuckles of the second portion 1410 that are configured to receive a bolt or pin therethrough to form the hinge are arranged to sit either side of the curved portion or knuckle of the first portion 1450 of the bracket. In this way the hinged bracket may be more stable and increase stability of a screen system using such a hinged bracket.

The second portion 1410 and first portion 1450 are biased relative to each other such that movement of one of the portions relative to the other is stiffer in a first direction compared to movement in a second direction opposite to the first direction. In the example shown, movement of the first portion 1450 relative to the second portion 1410 is stiffer in a direction into the page (i.e., in a distal direction) as opposed to movement towards the viewer (i.e., in a proximal direction). In the example shown in FIG. 14A, it can be seen that proximal portion 1457 and distal portion 1455 both have a curved profile to accommodate the curved or arcuate profile of the support element. The support element therefore has a concave surface (the proximal surface) and a convex surface (the distal surface). In the example shown the hinged bracket is configured to be stiffer in a distal direction (i.e., towards the curved concave surface of the support element and into the page) as opposed to in a proximal direction (i.e., towards the convex surface of the support element and out of the page).

Providing a hinged bracket that has a biasing means that is arranged to be stiffer in a first direction compared to a second direction is advantageous as the support element is less prone to bending/deflection when force is applied in a transverse direction to the concave surface of the support element than it is when a force is applied in a transverse direction to the convex surface. By providing such a hinged bracket, a screen system incorporating such a bracket may be more resilient, more stable, and may inhibit snaking when the screen is retracted or pushed back into a coiled or reeled state on a roll. By minimising bending to the support element that may otherwise occur, this may inhibit damage occurring to the support element and thereby prolonging the working life of the support element.

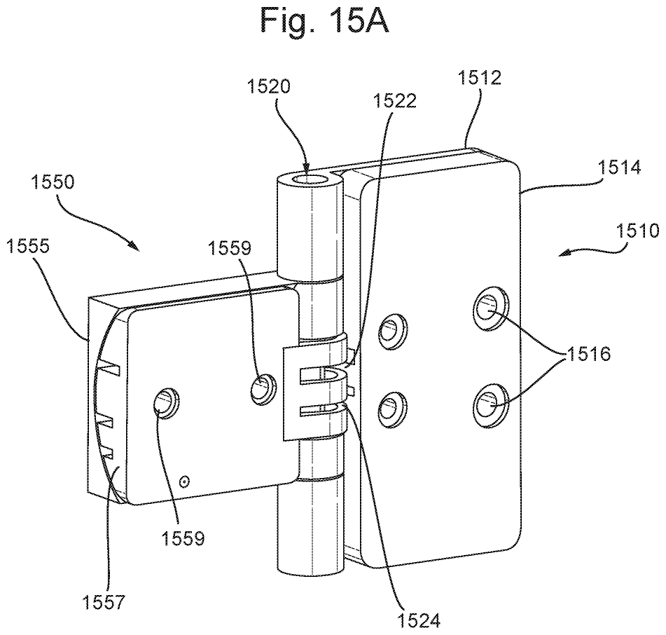

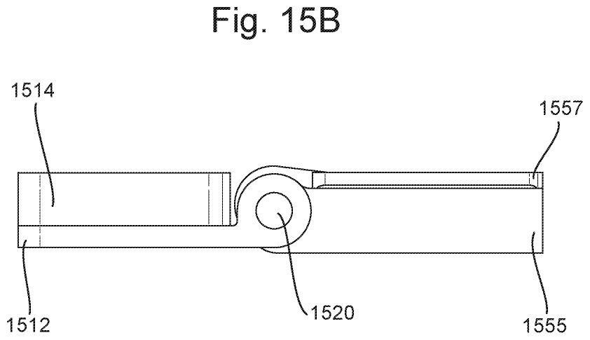

FIG. 15A shows a perspective view of another example hinged bracket for supporting a screen structure, and FIG. 15B shows a side view of the example hinged bracket of FIG. 15A. The example shown in FIGS. 15A and 15B is very similar to the example shown in FIGS. 14A and 14B with like reference numerals indicating the same features or features with similar functionality, however in this example the proximal portion 1557 of the first portion 1550 also comprises a curved portion or knuckle for receiving a bolt or pin therethrough about which the hinge rotates. In this example therefore both the proximal 1557 and distal 1555 portions of the first portion 1550 comprise curved portions or knuckles providing the hinge. This may serve to improve stability of the hinge and therefore resilience and stability of a screen system using such a hinge. In this example, the cut-outs 1522 and 1524 for the opposing springs forming the biasing means are both provided in the curved portion or knuckle of the proximal portion 1557 of the first portion 1550.

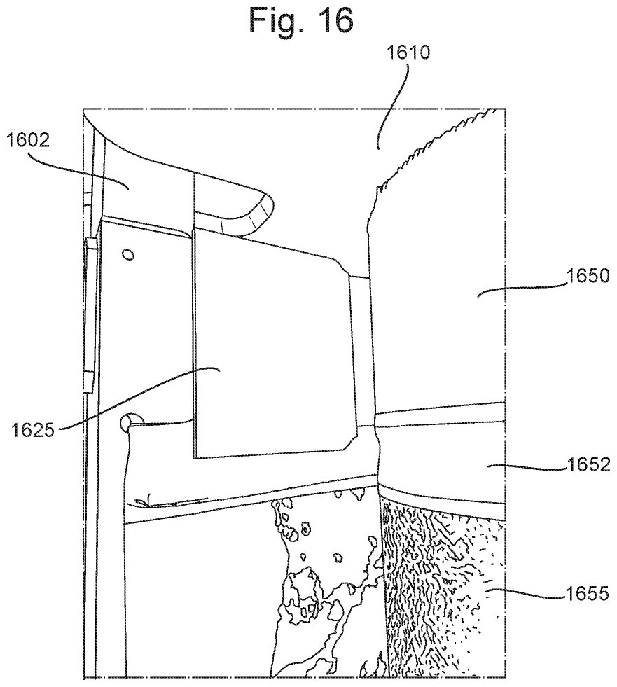

FIG. 16 shows a perspective view of a clamp element 1625 for clamping a portion of a support element 1650. In this example the support element 1650 is a split tube extendable member and is a bistable extendable member. The clamp 1625 is fixed to a handle element 1602 and clamps both the support element 1650 and a hem portion 1652 of the panel element 1655. The hem portion 1652 is a region to which both the support element 1650 and the panel element 1655 are affixed (in this example, stitched, but they could also be glued or zipped) and permits the support element 1650 to switch between a first (flat) state when rolled to second (arcuate) state when extended. In the example shown the clamp element 1625 is configured to clamp the support element 1650 in the second (arcuate) state, which improves the strength and resilience of the screen structure. Furthermore, by clamping the support element 1650 in the second (arcuate) state this may mitigate against damage that may occur to the support element 1650 that may otherwise occur when it transitions between the first (flat) state and the second (arcuate) state when rolled and unrolled whilst coupled to/supported by the handle element 1602. Also shown in FIG. 16 is a guide plate 1610 for receiving the handle element 1602 and holding the handle element 1602 proximate to the rolled panel and support elements. This may advantageously minimise damage and rubbing that may occur between the handle element 1602 and the support element 1650.

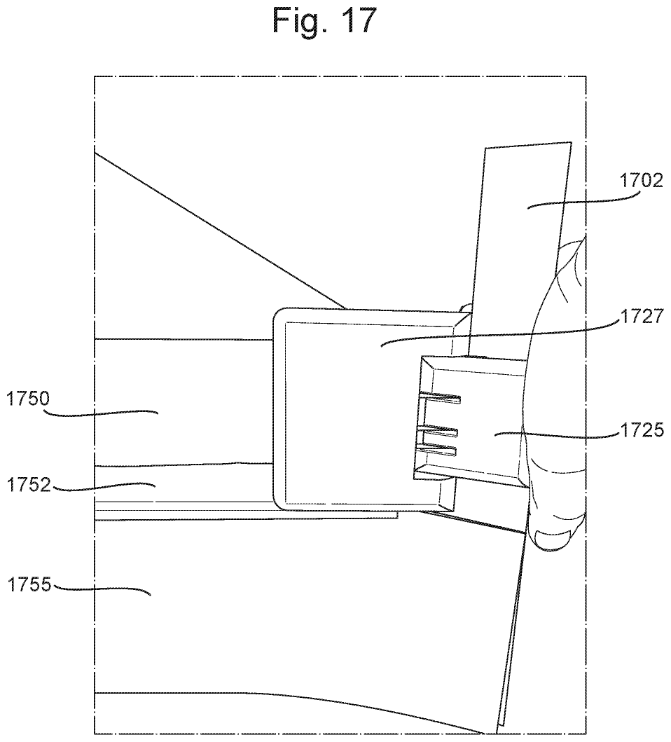

FIG. 17 shows a perspective view of an example hinged bracket also comprising a clamp element. The hinged bracket of FIG. 17 is very similar to the hinged brackets of FIGS. 14A to 15B and also comprises a clamp element. In this example it can be seen how the hinge element 1725 is coupled to a spine element 1702 and comprises a clamp portion 1727 for clamping the support element 1750 and a portion of the hem portion 1752 coupling the panel element 1755 to the support element 1750.

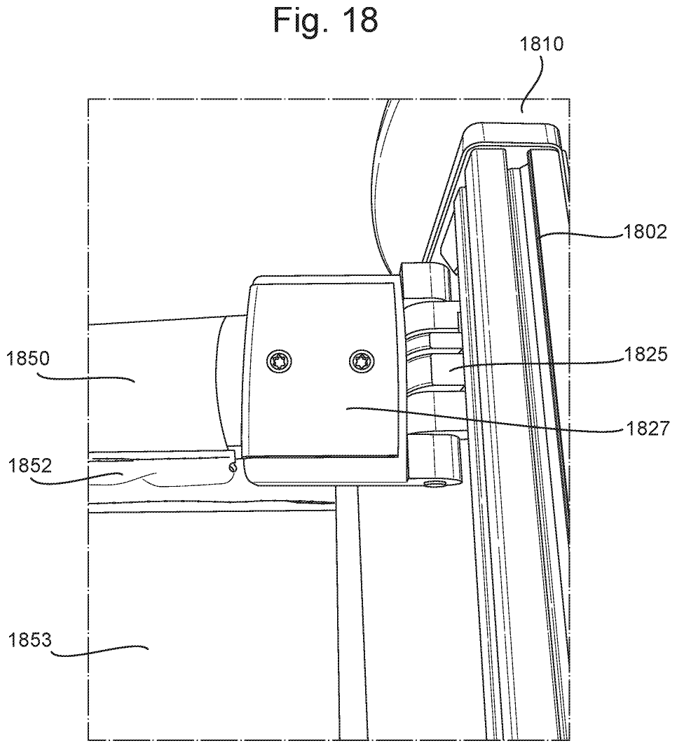

FIG. 18 shows a perspective view of another example hinged bracket also comprising a clamp element 1827. Again, the hinged bracket of FIG. 18 is very similar to the hinged brackets of FIGS. 14A to 15B and 17. In this example it can be seen how the hinge element 1825 is coupled to a spine element 1802 and comprises a clamp portion 1827 for clamping the support element 1850 and a portion of the hem portion 1852 coupling the panel element 1855 to the support element 1850. Similar to the example shown in Figure. 16, there is also a guide element 1810 configured to receive a handle element when the panel element 1855 and support element 1850 are retracted and rolled.

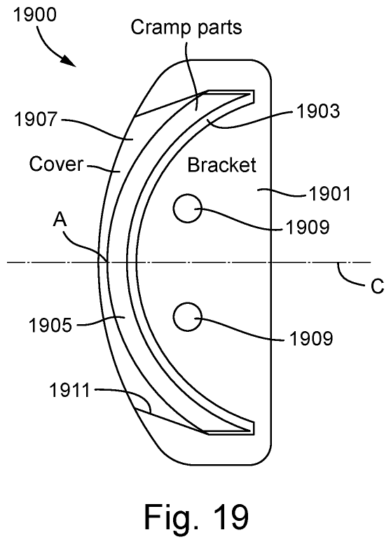

FIG. 19 shows a cross-section through another example bracket 1900. The bracket 1900 of FIG. 19 may be combined with the hinged bracket of FIGS. 14A to 18 described above. The bracket 1900 is configured to clamp a support element such as a bistable extendable member in a curved, unrolled configuration (for example as shown in FIGS. 1A, 1C and 2B as discussed above).

In the example shown in FIG. 19, the bracket 1900 comprises a bracket body 1901 having a curved receiving portion 1903 that is curved to follow the profile of the curvature of the cross-sectional profile of the bistable extendable member. The curvature of the curved receiving portion 1903 has an apex A approximately at the centreline C of the bracket body 1901, and the bracket body 1901 in the example shown is symmetrical about this centreline although it will be understood that in other examples symmetry is not a requirement for performing the function of clamping the bistable extendable member.

The bracket 1900 also comprises a cramp part 1905 that has an inner surface that also is curved to mirror the curvature of the curved profile of the curved receiving portion 1903, to follow the profile of the curvature of the cross-sectional profile of the bistable extendable member. The cramp part 1905 is configured to clamp the bistable extendable member in the receiving portion in the curved, unrolled configuration between the cramp part 1905 and the curved receiving portion 1903.

The bracket 1900 has a longitudinal axis (extending into the page) parallel to the longitudinal axis of the bistable extendable member when clamped by the bracket 1900 in use.

The body of the bracket 1901 is configured to be coupled to a supporting surface, such as at least one of a spine element and a handle element. In the example shown, the bracket 1901 is configured to be coupled to the at least one of a spine element and a handle element via a removable fastening means extending in the longitudinal axis of the bracket 1901 through fastening holes 1909.

The cramp part 1905 is configured to be removably fastened to the curved receiving portion 1903 of the bracket 1900 to clamp the bistable extendable member therebetween.

The cramp part 1905 is configured to be removably fastened to the receiving portion 1903. This may be via removable fastening means (not shown) extending in a direction perpendicular to the longitudinal axis of the bracket 1900 (and perpendicular to the direction of the fastening holes 1909). Additionally, or alternatively, the cramp part 1905 is configured to be removably fastened to the curved receiving portion 1903 via an interference fit.

The bracket 1900 further comprises a cover plate 1907. The cover plate 1907 is configured to be received by the receiving portion 1903 to cover the cramp part 1905 in use. In the example shown, the receiving portion 1903 comprises a pair of opposing lips 1911 extending parallel to the longitudinal axis of the bracket configured to receive and engage the cover plate 1907 via an interference fit to cover the cramp part 1905. The opposing lips 1911 are angled to provide a ledge or lip extending in towards the centreline C of the bracket body 1901 and towards the apex A of the curvature of the curved receiving portion 1903. The opposing lips 1911 act to retains the cover plate 1907 in place in the receiving portion 1903 of the bracket body 1901. The removable lips 1911 may form a channel extending in the longitudinal axis of the bracket body 1901 to allow the cover plate to slide into place and resist movement in a direction transverse to the longitudinal axis.

In this way, any removable fastening means coupling the cramp part 1905 to the bracket body 1901 are not visible in use. Alternatively, the cover plate 1907 may be retained by the opposing lips 1911 via an interference fit such that the hold the cramp part 1905 against the bistable extendible member and against the receiving portion 1903 to clamp the bistable extendible member in place. In such an example removable fastening means may not be required to fasten the cramp part 1905 to the curved receiving portion 1903.

As noted above, a series of screen systems 500 may be used adjacent to each other, e.g., to provide privacy to a series of beds on a ward of a hospital. In such examples, it may be desirable to couple the handle element 514 and/or the second base portion 545 of a screen structure of a first screen system to a portion of a screen structure of an adjacent screen system, so as to minimise the gap between panel elements of adjacent screen systems.

For example, the handle element 514 and/or the second base portion 545 of one screen system may be configured to couple to a base portion such as the first base portion 575 of an adjacent screen structure and/or the spine element 520 of an adjacent screen structure of an adjacent screen system. It will therefore be understood that the handle element 514 and/or base element 545 may comprise means to detachably couple to at least a portion of another screen structure. The means to detachably couple may comprise a latch or locking mechanism, a magnetic catch, or any other similar mechanism to permit detachable fastening.

In some examples the handle element 514 may comprise a screen extension to minimise the gap between adjacent screen structures of adjacent screen systems when placed in close proximity. The screen extension may comprise means to detachably couple to at least a portion of another screen structure. For example, the screen extension may comprise a latch or locking mechanism, a magnetic catch, or any other similar mechanism to permit detachable fastening.

Similarly, a screen structure may comprise a cover for covering at least a portion of the panel element and/or support element. The cover may act to protect the panel element and/or support element when wound onto the rotor from damage, may help to provide hygiene and may improve the aesthetics of the screen system by hiding the mechanics of the screen structure from visibility in use. The cover may also act to minimise the gap between adjacent screen structures of adjacent screen systems in use. For example, the cover may be configured to engage with the detachable coupling means of the handle element and/or screen extension. For example, the cover may be magnetic or have one or more magnetic portions to couple to the handle element or screen extension.

As noted above, the first base portion may be operable between a first moveable configuration and a second parked configuration, wherein in the first moveable configuration the relative position of the rotor 516b of the second screen structure across the surface 400 is moveable relative to the rotor 516a of the first screen structure, but wherein in the second parked configuration movement of the rotor 516b of the second screen structure across the surface 400 relative to the rotor of the first screen structure is inhibited. In some examples movement between the first moveable configuration and a second parked configuration may be actuated by an actuating mechanism, for example on the handle and/or the screen extension. In some examples, the actuating mechanism may be actuatable by an actuating means on the handle element 514 of the second screen structure 553 (for example by a means for gripping by a user, such as a handle or knob as described above) and/or on a screen extension. The actuating means may be, for example, a button or lever located in or on the handle element 514 and/or screen extension.

Also as noted above, the handle element also comprises a latch mechanism (not shown) configured to engage the horizontal bar to detachably secure the handle element 514 to the first base portion 575. The latch mechanism may be actuatable by a lock actuating means on the handle element 514 of the second screen structure 553 (for example by a means for gripping by a user, such as a handle or knob as described above) and/or on a screen extension (as described in more detail below with reference to FIG. 20). The lock actuating means may be, for example, a button or lever located in or on the handle element 514 and/or screen extension.

FIG. 20 shows a perspective view of an of a portion of a screen structure such as the screen structure of FIG. 5 with a screen extension extending from the handle. As with the example embodiment of FIG. 5, the screen structure shown in FIG. 20 comprises a panel element 544b attached to a first support element 503a and a second support element 503b (not shown) on opposing sides of the panel element 544b. The support elements 503a, 503b and the panel element 544b are attached to and configured to be rollable about a rotor 516a (not shown) configured to rotate about a longitudinal axis to provide for extension and retraction thereof along a direction generally perpendicular to the longitudinal axis. The support elements 503a, 503b thus extend in a direction perpendicular to the longitudinal axis when extended and unrolled from the rotor. A handle element 514 is coupled to an end of the first and second support elements (503a, 503b) and the panel element 544b for extending and retracting the at least one support element and the panel element upon application of a force to the handle element.

A screen extension 2001 extends perpendicularly from the handle element 514 opposite to the panel element 544b and the first and second support elements 503a, 503b. The screen extension 2001 extends from the handle element 514 in the same direction as the panel element 544b and the first and second support elements 503a, 503b extend from the rotor. The screen extension 2001 in the example shown has approximately the same dimensions in the longitudinal axis as the panel element 544b and the first and second support elements 503a, 503b combined, such that the height of the screen extension 2001 in the longitudinal axis is the same as that of the panel element 544b and the first and second support elements 503a, 503b combined. At either end of the screen extension 2001 in the longitudinal axis (or height direction) the screen extension comprises a curved or teardrop-shaped portion 2003, approximately of the same height as the support element and having a teardrop shape when taken in cross-section parallel to the longitudinal axis. The curved portion 2003 provides strength to the screen extension 2001. The curved portion 2003 also comprises means to detachably couple to at least a portion of another screen structure. In the present example, each curved portion 2003 comprises a respective magnetic for coupling to magnetic material, for example of an adjacent screen structure as shown in 22 and discussed in more detail below, such that the screen extension 2001 comprises a pair of magnets at opposing ends of the screen extension 2001 in the longitudinal axis.

Provided within the screen extension is an actuatable means 2005. The actuatable means 2005 is configured to operate a latch mechanism (not shown), as described above, that may be configured to engage the horizontal bar to detachably secure the handle element 514 to the first base portion 575. The actuatable means 2005 comprises a pair of gripping rods or poles with user actuatable levers on opposing sides of the screen extension 2001. The actuatable levers may be squeezed against the gripping rods or poles to operate the latch mechanism to release the handle element 514 from the first base portion 575 to release and allow deployment of the second screen structure while parking the first base portion 575 in a parked configuration. Advantageously providing such an actuatable means that the user conveniently only has to operate/hold only one part of the screen system for it to be deployed effectively.

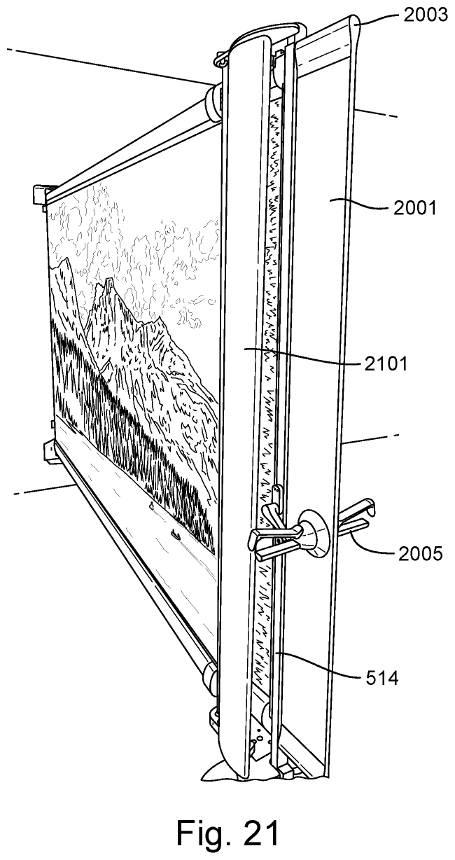

FIG. 21 shows another perspective view of the example handle 514 and screen extension 2001 of FIG. 20. As shown in FIG. 21, the screen structure comprises a magnetic cover 2101 for covering at least a portion of the panel element 544b and the support elements 503a, 503b when rolled about the rotor. The cover 2101 is magnetic in the sense that it is ferromagnet and attracted to a magnet, for example the cover 2101 may comprise iron and/or be made from steel.

FIG. 22 shows another perspective view of the example handle 514 and screen extension 2001 of FIGS. 20 and 21. As shown in FIG. 22, the screen extension 2001 of a screen structure of a first screen system is coupled to the cover 2101 of a screen structure of an adjacent, second, screen system. As can be seen, this reduces any visible gap between the adjacent screen systems, providing privacy to anyone behind the screens, such as patients in a hospital ward.

To enable the second screen structure of a first screen system, and in particular the screen extension 2001, to get as close as possible to the cover 2101, the second base portion 545 comprises a region configured to mate with the first base portion 575 of another screen system. In the example shown, the second base portion 545 comprises rolling means configured to permit relative movement of the second base portion 545 relative to the surface. In the example shown, the second base portion 545 comprises a first region 2225 on a side of the second base portion proximate to the at least one panel element 544b and support elements 503a, 503b, and a second region 2227 on a side of the second base portion 545 distal to the panel element 544b and support elements 503a, 503b. The second base portion 545 is shaped to mate with the first base portion 575 of another screen structure, so as to enable the handle element 514 to be close to the rotor 516b of the other screen structure to minimise the gap between panel elements of adjacent screen structures. In the example shown, the second region 2227 of the second base portion 545 is shaped to have a profile that corresponds to the profile of the shroud element 603 of the first base portion 575 of the screen structure of the adjacent screen system so that the second region 2227 of the second base portion 545 is configured to abut the shroud element 603 of the first base portion 575 adjacent screen system.

It will be appreciated from the discussion above that the embodiments shown in the Figures are merely exemplary, and include features which may be generalised, removed or replaced as described herein and as set out in the claims. In the context of the present disclosure other examples and variations of the apparatus and methods described herein will be apparent to a person of skill in the art.

1. A screen system for deployment over a surface, comprising:
a first screen structure and a second screen structure, wherein each screen structure comprises a panel element attached to at least one support element, wherein the at least one support element and the panel element are attached to and configured to be rollable about a rotor configured to rotate about a longitudinal axis to provide for extension and retraction thereof along a direction generally perpendicular to the longitudinal axis; and
wherein the rotor of the second screen structure is configured to be moveable relative to the rotor of the first screen structure.

2. The screen system of claim 1 wherein the at least one support element of the first screen structure is pivotably coupled to the second screen structure, such that the angle of the panel element of the first screen structure relative to the rotor of the second screen structure is adjustable.

3. The screen system of claim 1 wherein the second screen structure comprises a first base portion configured to be engageable with a surface over which the second screen structure is deployed or is to be deployed to support the rotor and therefore panel in an upright orientation generally perpendicular to the surface wherein the first base portion is operable between a first moveable configuration and a second parked configuration; wherein in the first moveable configuration the relative position of the rotor of the second screen structure across the surface is moveable relative to the rotor of the first screen structure, but wherein in the second parked configuration movement of the rotor of the second screen structure across the surface relative to the rotor of the first screen structure is inhibited,
wherein the second screen structure comprises:
an actuating mechanism, operable by retraction or extension of the at least one support element and the panel element, to move the first base portion between the first moveable configuration and the second parked configuration.

4.-5. (canceled)

6. The screen system of claim 3 wherein the second screen structure comprises a handle element for extending and retracting the at least one support element and the panel element upon application of a force to the handle element; and
wherein at least a portion of the handle element is configured to engage the actuating mechanism to move the first base portion between the first moveable configuration and the second parked configuration, such that when the handle element bears against the actuating mechanism the first base portion is held in the first moveable configuration, and when the handle element no longer bears against the actuating mechanism the first base portion is in the second parked configuration;
wherein the second screen structure comprises a guide element configured to receive at least a portion of the handle element and configured to guide at least a portion of the handle element towards the actuating mechanism;
wherein the handle element of the second screen structure comprises an engagement portion configured to be guided by the guide element and configured to engage the locking mechanism;
further comprising a locking mechanism to removably secure the handle element of the second screen structure to the first base portion, wherein the locking mechanism is actuatable by a lock actuating means on the handle element of the second screen structure.

7.-9. (canceled)

10. The screen system of claim 1 wherein the first base portion comprises rolling means and a shroud element, and wherein in the first moveable configuration the at least one shroud element is raised relative to the rolling means to permit movement of the rolling means on the surface, and wherein in the second parked position the at least one shroud element is lowered relative to the rolling means to engage the surface and inhibit movement of the rolling means on the surface.

11. The screen system of claim 5 wherein the actuating mechanism comprises a lever arm, and wherein at least a portion of the handle element is configured to engage the lever arm to actuate the actuating mechanism to lift or lower the shroud element of the first base portion relative to the rolling means.

12. The screen system of claim 6 wherein the lever arm is coupled to the shroud via an eccentric pivot.

13. The screen system of claim 6 wherein the actuating mechanism comprises (i) a bell crank, or (ii) a hydraulic piston, and wherein at least a portion of the handle element is configured to engage a hydraulic actuator in a first axis to actuate the hydraulic piston to lift or lower the shroud element of the first base portion relative to the rolling means in a direction transverse to the first axis.

14. (canceled)

15. The screen system of claim 3 wherein the handle element of the second screen structure has a longitudinal axis, and the handle element of the second screen structure comprises a second base portion configured to support the handle element, and thereby the panel element, in a generally perpendicular orientation relative to the surface, and parallel to the longitudinal axis of the rotor of the second screen structure;
wherein as the handle element of the second screen structure bears against the actuating mechanism to move the first base portion between the second parked position and the first moveable position, the second base portion coupled to the handle element is raised off of the surface by the base portion;
wherein the second base portion comprises rolling means configured to permit relative movement of the second base portion of the second screen structure relative to the surface.

16.-17. (canceled)

18. The screen system of claim 9, wherein the second base portion comprises a first region on a side of the second base portion proximate to the at least one panel element and support element, and a second region on a side of the second base portion distal to the panel element and at least one support element, wherein the second region is shaped to have a profile that corresponds to the profile of the shroud element so that the second base portion is configured to abut the shroud element of an adjacent screen system.

19. The screen system of claim 1 wherein the first screen structure comprises at least one hinge arrangement coupled to the rotor of the first screen structure and configured to provide for the rotor of the first screen structure to pivot about a second longitudinal axis arranged generally parallel to the longitudinal axis of the rotor of the second screen structure.

20. The screen system of claim 1 wherein the at least one support element of each screen structure comprises a bistable extendable member.

21. A screen structure for deployment over a surface, comprising:
a panel element attached to at least one support element, wherein the at least one support element and the panel element are attached to and configured to be rollable about a rotor configured to rotate about a longitudinal axis to provide for extension and retraction thereof along a direction generally perpendicular to the longitudinal axis; and
a first base portion configured to be engageable with and support the rotor in an upright orientation relative to the surface over which the screen structure is deployed or is to be deployed;
wherein the first base portion is operable between a first moveable configuration and a second parked configuration, wherein in the first moveable configuration the relative position of the rotor of the screen structure across the surface is moveable, but wherein in the second parked configuration movement of the rotor of the screen structure across the surface is inhibited.

22. The screen structure of claim 13 further comprising an actuating mechanism, operable by retraction or extension of the at least one support element and the panel element, to move the first base portion between the first moveable configuration and the second parked configuration;
further comprising a handle element for extending and retracting the at least one support element and the panel element upon application of a force to the handle element; and
wherein at least a portion of the handle element is configured to engage the actuating mechanism to move the first base portion between the first moveable configuration and the second parked configuration, such that when the handle element bears against the actuating mechanism the first base portion is held in the first moveable configuration, and when the handle element no longer bears against the actuating mechanism the first base portion is in the second parked configuration.

23. (canceled)

24. The screen structure of claim 14 wherein the first base portion comprises a guide element configured to receive at least a portion of the handle element and configured to guide at least a portion of the handle element towards the actuating mechanism.

25. The screen structure of claim 14 further comprising a locking mechanism to removably secure the handle element of the second screen structure to the first base portion, wherein the locking mechanism is actuatable by a lock actuating means on the handle element of the second screen structure.

26. The screen structure of claim 13 wherein the first base portion comprises rolling means and a shroud element, and wherein in the first moveable configuration the at least one shroud element is raised relative to the rolling means to permit movement of the rolling means on the surface, and wherein in the second parked position the at least one shroud element is lowered relative to the rolling means to engage the surface and inhibit movement of the rolling means on the surface.

27. The screen structure of claim 17 wherein the locking means comprises a lever arm, and wherein the handle element is configured to engage the lever arm to actuate the locking mechanism to lift or lower the shroud element of the first base portion relative to the rolling means.

28. The screen structure of claim 18 wherein the lever arm is coupled to the shroud via an eccentric pivot.

29. The screen structure of claim 13 wherein the at least one support element comprises a bistable extendable member.

30.-61. (canceled)
